(19) United States
(12) Patent Application Publication
(10) Pub. No.: US 2026/0313417 A1
(43) Pub. Date: Oct. 8, 2026

(54) UE SELECTING AND REPORTING THE NUMBER OF SPATIAL BEAMS FOR COHERENT JOINT TRANSMISSION

(71) Applicant: Telefonaktiebolaget LM Ericsson (publ), Stockholm (SE)

(72) Inventors: Shiwei Gao, Nepean (CA); Siva Muruganathan, Stittsville (CA)

(21) Appl. No.: 19/100,693

(22) PCT Filed: Aug. 4, 2023
(86) PCT No.: PCT/IB2023/057926

§ 371 Date: Feb. 3, 2025

Related U.S. Application Data
(60) Provisional application No. 63/395,629, filed on Aug. 5, 2022.

(51) Int. Cl. H04W 24/10; H04B 7/022; H04L 5/00

(52) U.S. Cl. CPC H04W 24/10; H04B 7/022; H04L 5/0051

(57) ABSTRACT

The present disclosure relates to a method for Type II Channel State Information (CSI) reporting when it is used for Coherent Joint Transmission (CJT) to a User Equipment device (UE) from multiple transmission/reception points (TRPs). The network node can configure a UE with CSI reference signals (CSI-RS) resources each associated to respective TRPs. The UE can measure the channels and send a CSI report back to the network node that includes CSI measurements. The CSI report can also include a number of selected spatial beams or CSI-RS ports for each CSI-RS resource of the CSI-RS resources. The CSI report may also include a number of Frequency Domain (FD) basis vectors selected based on the number of selected spatial beams or CSI-RS ports for each CSI-RS resource of the CSI-RS resources.

### RELATED APPLICATIONS

This application claims the benefit of provisional patent application Ser. No. 63/395,629, filed Aug. 5, 2022, the disclosure of which is hereby incorporated herein by reference in its entirety.

### TECHNICAL FIELD

The present disclosure relates to a method for selection and reporting of numbers of spatial beams for coherent joint transmission in a wireless communication system.

### BACKGROUND

### A. Codebook-Based Precoding

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

A core component of the Fifth Generation (5G) wireless network or New Radio (NR) is the support of MIMO antenna deployments and MIMO related techniques such as spatial multiplexing. Spatial multiplexing can be used to increase data rates in favorable channel conditions. FIG. 1 shows an example of spatial multiplexing. An information carrying symbol vector s 102 is multiplied by an N_{T}×r precoding matrix or precoder W 104, which serves to distribute the transmit energy in a subspace of the N_{T} dimensional vector space. The precoding matrix is typically selected from a codebook of possible precoding matrices, and typically indicated by means of a precoding matrix indicator (PMI), which specifies a unique precoding matrix in the codebook for a given number of symbol streams. The r symbols 106 in s 102 each correspond to a MIMO layer and r 106 is referred to as the transmission rank, which equals to the number of columns of the precoder W 104. In this way, spatial multiplexing is achieved since multiple symbols can be transmitted simultaneously over the same time/frequency resource element (RE). The number of symbols r is typically adapted to suit the current channel properties.

NR uses Orthogonal Division Multiplexing (OFDM) in downlink. The received N_{R}×1 vector yₙ at a User Equipment device (UE) on a certain RE can be expressed as

$${y}_{n} = {H}_{n} W {s}_{n} + {e}_{n}$$

where eₙ is a receiver noise/interference vector. The precoder W 104 can be constant over frequency (i.e., wideband), or frequency selective (i.e., per subband).

The precoder W 104 is chosen to match the characteristics of the N_{R}XN_{T} MIMO channel matrix Hₙ, resulting in so-called channel dependent precoding. This is also commonly referred to as closed-loop precoding.

In closed-loop precoding, the UE feeds back recommendations on a suitable precoder to the NR Node B (gNB) in the form of a PMI based on downlink channel measurements. For that purpose, the UE is configured with a channel state information (CSI) report configuration including CSI reference signals (CSI-RS) for channel measurements and a codebook (CB) of candidate precoders. In addition to precoders, the feedback may also include a rank indicator (RI) and one or two channel quality indicators (CQIs). RI, PMI and CQI are part of a CSI feedback. In NR, CSI feedback can be either wideband, where one CSI is reported for the entire channel bandwidth, or frequency-selective, where one CSI is reported for each subband, which is defined as a number of contiguous physical resource blocks (PRBs) ranging between 4-32 PRBs depending on the band width part (BWP) size.

Given the CSI feedback from the UE, the gNB determines the transmission parameters it wishes to use to transmit to the UE, including the precoding matrix, transmission rank, and modulation and coding scheme (MCS).

### B. 2D Antenna Arrays

Two-dimensional (2D) antenna arrays are widely used and such antenna arrays can be described by a number of antenna ports, N₁, in a first dimension (e.g., the horizontal dimension), a number of antenna ports, N₂, in the second dimension perpendicular to the first dimension (e.g., the vertical dimension), and a number of polarizations Nₚ. The total number of antenna ports is thus N=N₁N₂Nₚ. The concept of an antenna port is non-limiting in the sense that it can refer to any virtualization (e.g., linear mapping) to the physical antenna elements. For example, pairs of physical antenna elements could be fed the same signal, and hence share the same virtualized antenna port.

An example of a 4×4 (i.e., N₁×N₂,) array with dual-polarized antenna elements (i.e., Nₚ=2) is illustrated in FIG. 2. (Nₚ=2), with N₁=4 horizontal antenna elements 202 and N₂=4 vertical antenna elements 204.

Precoding may be interpreted as multiplying the signal to be transmitted by a set of beamforming weights on the antenna ports prior to transmission. A typical approach is to tailor the precoder to the antenna form factor, i.e., taking into account N₁, N₂ and Nₚ when designing the precoder codebook.

### C. Channel State Information Reference Signals (CSI-RS)

For CSI measurement and feedback, CSI-RS are defined. A CSI-RS is transmitted on an antenna port at the gNB and is used by a UE to measure downlink channel between the antenna port and each of the UE's receive antenna ports. The transmit antenna ports are also referred to as CSI-RS ports. The supported number of CSI-RS ports in NR are {1,2,4,8,12,16,24,32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain REs in a slot and certain slots. FIG. 3 shows an example of CSI-RS REs 304 for 12 antenna ports 302, where 1RE per RB per port is shown.

In addition, an interference measurement resource (IMR) is also defined in NR for a UE to measure interference. An IMR resource contains 4 Res, either 4 adjacent RE in frequency in the same OFDM symbol or 2 by 2 adjacent Res in both time and frequency in a slot. By measuring both the channel based on NZP CSI-RS and the interference based on an IMR, a UE can estimate the effective channel and noise plus interference to determine the CSI. Furthermore, a UE in NR may be configured to measure interference based on one or multiple NZP CSI-RS resource.

### D. CSI Framework in NR

In NR, a UE can be configured with multiple CSI reporting settings and multiple CSI-RS resource settings. Each resource setting can contain multiple resource sets, and each resource set can contain up to 8 CSI-RS resources. For each CSI reporting setting, a UE feeds back a CSI report.

Each CSI reporting setting contains at least the following information:
A CSI-RS resource setting for channel measurement;
An IMR resource set for interference measurement;
Optionally, a CSI-RS resource set for interference measurement;
Time-domain behavior, i.e., periodic, semi-persistent, or aperiodic reporting;
Frequency granularity, i.e., wideband or subband;
CSI parameters to be reported such as RI, PMI, CQI, and CSI-RS resource indicator; (CRI) in case of multiple CSI-RS resources in a resource set;
Codebook types, i.e., type I or II, and codebook subset restriction;
Measurement restriction; and
Subband size. One out of two possible subband sizes is indicated, the value range depends on the bandwidth of the BWP. One CQI/PMI (if configured for subband reporting) is fed back per subband).

### E. DFT-Based Precoders

A common type of precoding is to use a DFT-precoder, where the precoder vector used to precode a single-layer transmission on a single-polarized uniform linear array (ULA) with N antennas is defined as:

$${w}_{1 D} ( k ) = {u}_{k} = \frac{1}{\sqrt{N}} [ \begin{matrix}{e}^{j 2 π \cdot 0 \frac{k}{ON}} \\ {e}^{j 2 π \cdot 1 \frac{k}{ON}} \\ ⋮ \\ {e}^{j 2 π \cdot ( N - 1 ) \frac{k}{ON}}\end{matrix} ] ,$$

where k=0, 1, . . . ON−1 is the precoder index and O is an integer oversampling factor. uₖ is also referred to as a one dimension (1-D) DFT beam with beam index k. If ULA is along the horizontal dimension, each DFT beam points to an azimuth direction. If ULA is along the vertical dimension, each DFT beam points to an elevation direction. Each precoder corresponds to a DFT beam.

A corresponding precoder vector for a two-dimensional uniform planar array (UPA) with N₁ antenna ports in one dimension and N₂ antenna ports in another dimension can be created by taking the Kronecker product of two precoder vectors as

$${W}_{2 D} ( k , l ) = {v}_{k , l} = {u}_{k , 1} ⊗ {u}_{l , 2} ,$$

where

$${u}_{k , 1} = \frac{1}{\sqrt{{N}_{1}}} [ \begin{matrix}{e}^{j 2 π \cdot 0 \frac{k}{{O}_{1} {N}_{1}}} \\ {e}^{j 2 π \cdot 1 \frac{k}{{O}_{1} {N}_{1}}} \\ ⋮ \\ {e}^{j 2 π \cdot ( {N}_{1} - 1 ) \frac{k}{{O}_{1} {N}_{1}}}\end{matrix} ] and {u}_{l , 2} = \frac{1}{\sqrt{{N}_{2}}} [ \begin{matrix}{e}^{j 2 π \cdot 0 \frac{l}{{O}_{2} {N}_{2}}} \\ {e}^{j 2 π \cdot 1 \frac{l}{{O}_{2} {N}_{2}}} \\ ⋮ \\ {e}^{j 2 π \cdot ( {N}_{2} - 1 ) \frac{l}{{O}_{2} {N}_{2}}}\end{matrix} ]$$

are 1-D DFT beams in each of the two dimensions, and O₁ and O₂ are the over sampling factors in the two dimensions associated with N₁ and N₂, respectively. v_{k,l} is also referred to as a two dimensional (2-D) DFT beam characterized by two beam indices (k,l), one in each dimension. Each precoder corresponds to a 2D DFT beam.

Extending the DFT precoder for a dual-polarized UPA may then be done as

$${w}_{2 D , DP} ( k , l , ϕ ) = [ \begin{matrix}1 \\ {e}^{j ϕ}\end{matrix} ] ⊗ {w}_{2 D} ( k , l ) = [ \begin{matrix}{w}_{2 D} ( k , l ) \\ {e}^{j ϕ} {w}_{2 D} ( k , l )\end{matrix} ] = [ \begin{matrix}{w}_{2 D} ( k , l ) & 0 \\ 0 & {w}_{2 D} ( k , l )\end{matrix} ] [ \begin{matrix}1 \\ {e}^{j ϕ}\end{matrix} ] ,$$

where e^{jφ} is a co-phasing factor that may be selected from M-PSK alphabet such as QPK with

$$ϕ ∈ \{ 0 , \frac{π}{2} , π , \frac{3 π}{2} \} .$$

A precoder matrix W_{2D,DP} for multi-layer transmission may be created by appending columns of DFT precoder vectors as

$${W}_{2 D , D P} = [ \begin{matrix}{w}_{2 D , DP} ( {k}_{1} , {l}_{1} , {ϕ}_{1} ) & {w}_{2 D D P} ( {k}_{2} , {l}_{2} , {ϕ}_{2} ) & … & {w}_{2 D D P} ( {k}_{r} , {l}_{r} , {ϕ}_{r} ) ] ,\end{matrix}$$

where r is the number of transmission layers. Such DFT-based precoders are used for instance in NR Type I CSI feedback, where each layer is associated with 2D DFT beam.

### F. MU-MIMO

With multi-user MIMO (MU-MIMO), two or more users in the same cell are co-scheduled on a same time-frequency resource. That is, multiple data streams are transmitted to different UEs at the same time-frequency resource and each UE may be allocated with one or more layers. By transmitting several streams simultaneously, the capacity of the system can be increased.

To avoid across UE or layer interference, zero-forcing (ZF) type of precoders may be used in which the feedback precoders associated with all co-scheduled UEs in a same time frequency resource are used together to generate a set of new orthogonal precoders. This requires each of the feedback precoders to be a good representation of underlying channel.

However, a single DFT beam is generally not a good representation of the channel associated to a layer under multipath propagation as each layer may be transmitted over multiple paths each corresponding to a DFT beam.

To improve the above single DFT beam based precoder, type II codebook-based CSI feedback was introduced in NR Rel-15 and further enhanced in NR Rel-16 and Rel-17. The basic concept is that due to multipath propagation, each layer may contain more than one DFT beam. Hence an improved precoder may be created by combining multiple DFT beams for each layer and the UE feeds back both the multiple DFT beams and the combining coefficients.

### G. NR Rel-15 Type II Codebook

In NR Rel-15, precoders are enhanced based on a type II codebook, in which a precoder is a combination of multiple DFT beams. For each precoder, the UE feeds back the corresponding selected multiple DFT beams and the combination coefficients. A precoder may be reported for each layer and each subband. A common set of DFT beams are selected for all subbands and all layers. The number of DFT beams to be selected is Radio Resource Control (RRC) configured.

For a given 2D cross-polarized antenna array with N₁ antenna ports in one dimension and N₂ antenna ports in another dimension at each polarization, the NR Rel-15 type II codebook-based precoding vector for each layer l∈{1,2} and a subband can be expressed as:

$${w}_{l} = {W}_{1} {w}_{2 , l}$$

where:

$${W}_{1} = [ \begin{matrix}{v}_{{m}_{1}^{( 0 )} , {m}_{2}^{( 0}} , … , {v}_{{m}_{1}^{( L - 1 )} , {m}_{2}^{( L - 1 )}} & 0 \\ 0 & {v}_{{m}_{1}^{( 0 )} , {m}_{2}^{( 0}} , … , {v}_{{m}_{1}^{( L - 1 )} , {m}_{2}^{( L - 1 )}}\end{matrix} ] ,$$

is a set size P_{CSI-RS}/2×1 selected 2-D DFT beams,

$${P}_{CSI - RS} = 2 {N}_{1} {N}_{2} , {m}_{1}^{( i )} ∈ \{ 0 , 1 , … , {O}_{1} {N}_{1} - 1 ) and$$

$${m}_{2}^{( i )} ∈ \{ 0 , 1 , … , {O}_{2} {N}_{2} - 1 )$$

are the beam indices in each dimension for the ith selected DFT beam. L∈{2,3,4} is the number of DFT beams to be selected and is configured by RRC; and
w_{2,l}=[w_{2,l,0}, w_{2,l,1}, . . . , w_{2,1,2L-1}]^{T}, where

$${w}_{2 , l , i} = {p}_{l , i}^{( 1 )} {p}_{l , i}^{( 2 )} {φ}_{l , i}$$

is the combining coefficient associated with the ith beam, and

$${p}_{l , i}^{( 1 )} , {p}_{l , i}^{( 2 )} ,$$

and φ_{l,i} are the wideband amplitude, subband amplitude, and phase factor of w_{2,l,i}, respectively.
wₗ is expressed in section 5.2.2.2.3 of 3GPP specification TS38.214 V15.16.0 as:

$${W}_{{q}_{1} , {q}_{2} , {n}_{1} , {n}_{2} , {p}_{l}^{( 1 )} , {p}_{l}^{( 2 )} , {c}_{1}}^{l} = \frac{1}{\sqrt{{N}_{1} {N}_{2} {\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{m}_{1}^{( i )} , {m}_{2}^{( i )}} {p}_{l , i}^{( 1 )} {p}_{l , i}^{( 2 )} {φ}_{l , i} \\ {\sum }_{i = 0}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] ,$$

$$l = 1 , 2$$

where

$${m}_{1}^{( i )} = {O}_{1} {n}_{1}^{( i )} + {q}_{1} , {m}_{2}^{( i )} = {O}_{2} {n}_{2}^{( i )} + {q}_{2} , {q}_{1} ∈ \{ 0 , 1 , … , {O}_{1} - 1 \} ,$$

$${q}_{2} ∈ \{ 0 , 1 , … , {O}_{2} - 1 \} , {n}_{1} = [ {n}_{1}^{( 0 )} , … , {n}_{1}^{( L - 1 )} ] , {n}_{2} = [ {n}_{2}^{( 0 )} , … , {n}_{2}^{( L - 1 )} ] ,$$

$${n}_{1}^{( i )} ∈ \{ 0 , 1 , … , {N}_{1} - 1 \} , {n}_{2}^{( i )} ∈ \{ 0 , 1 , … , {N}_{2} - 1 \} ,$$

$$i = 0 , 1 , … , L - 1. {p}_{l}^{( p )} = [ {p}_{l , 0}^{( p )} … {p}_{l , 2 L - 1}^{( p )} ] , p = 1 , 2.$$

### H. NR Rel-16 Enhanced Type II Codebook

The Rel-15 type II codebook is enhanced in NR rel-16 in which instead of reporting separate precoders for different subbands, the precoders for all subbands are reported together by using a so called frequency domain basis. It takes advantage of frequency domain channel correlations by representing the precoder changes in frequency domain with a set of frequency domain DFT basis vectors (which will be simply referred to as frequency domain basis vectors). Due to channel correlation in frequency, only a few DFT basis vectors may be used to represent the precoder changes over all the subbands. By doing so, the feedback overhead can be reduced, or performance can be improved for the same feedback overhead.

For a given CSI-RS resource with N₁ CSI-RS antenna ports in one dimension and N₂ CSI-RS antenna ports in another dimension, and with two polarizations, the Rel-16 type II codebook-based precoding vectors for each layer l (l=1, . . . , v) and across all subbands can be expressed as:

$${W}_{l} = [ {w}_{l}^{( 0 )} … {w}_{l}^{( {N}_{3} - 1 )} ] = {W}_{1} {\tilde{W}}_{2 , l} {W}_{f , l}^{H} ,$$

where:

$${w}_{l}^{( t )}$$

is a P_{CSI-RS}×1 precoding vector at a PMI subband with subband index t∈{0,1, . . . , N₃−1} for layer l, where P_{CSI-RS}=2N₁N₂ is the number of CSI-RS ports in a configured NZP CSI-RS resource;
N₃=N_{SB}×R is the number of subbands for PMI, where N_{SB} is the number of CQI subbands and R∈{1,2} is a scaling factor, both N_{SB} and R are RRC configured;
W₁ is the same as in Rel-15 type II codebook;

$${W}_{f , l} = [ {y}_{l}^{( 0 )} , {y}_{l}^{( 1 )} , … , {y}_{l}^{( {M}_{ν} - 1 )} ]$$

is a size N₃×Mᵥ frequency domain (FD) compression matrix for layer l comprising Mᵥ selected FD basis vectors and

$${y}_{l}^{( f )} = {[ {y}_{0 , l}^{( f )} , {y}_{1 , l}^{( f )} , … , {y}_{{N}_{3} - 1 , l}^{( f )} ]}^{T} and$$

$${y}_{t , l}^{( f )} = {e}^{- j 2 π {tn}_{3 , l}^{( f )} / {N}_{3}} , t = 0 , 1 , … , {N}_{3} - 1 ,$$

$${n}_{3 , l}^{( f )} ∈ \{ 0 , 1 , … , {N}_{3} - 1 \} , f = 0 , 1 , … , {M}_{v} - 1.$$

$${M}_{v} = ⌈ {p}_{v} \frac{{N}_{3}}{R} ⌉$$

is the number of selected FD basis vectors, which depends on the rank, v, and the RRC configured parameter pᵥ. Supported values of pᵥ can be found in Table 1;
   For N₃≤19, a one-step free selection is used;
      For each layer, the selected FD basis vectors are indicated with a

$$⌈ {log}_{2} ( \begin{matrix}{N}_{3} - 1 \\ {M}_{v} - 1\end{matrix} ) ⌉ bit$$

bit combinatorial indicator. In TS38.214 V15.16.0, the combinatorial indicator is given by index i_{1,6,l}, which is reported by UE to the gNB;
For N₃>19, a two-step selection with layer-common intermediary subset (IntS) is used;
   In the first step, a window-based layer-common IntS selection is used, which is parameterized by Mᵢₙᵢₜᵢₐₗ. The IntS consists of FD basis vectors {mod(Mᵢₙᵢₜᵢₐₗ, +n, N₃), n=0, 1, . . . , 2Mᵥ−1}. In TS38.214 V15.16.0, the selected IntS is reported by the UE to the gNB via the parameter i_{1,5}, which is reported per layer as part of the reported PMI;
   In the second step, the selected FD basis vectors are indicated with an

$$⌈ {log}_{2} ( \begin{matrix}2 {M}_{v} - 1 \\ {M}_{v} - 1\end{matrix} ) ⌉ - bit$$

combinatorial indicator for each layer. In TS38.214 V15.16.0, the combinatorial indicator is given by the index i_{1,6,l}, which is reported by UE to the gNB; and
\tilde{W}_{2,l}=[\tilde{w}_{l,i,f}, i=0, 1, . . . , 2L−1, f=0, 1, . . . , Mᵥ−1] is a size 2L× Mᵥ coefficient matrix. For layer l, only a subset of

$${K}_{l}^{NZ} \leq {K}_{0}$$

coefficients are non-zero and reported by the UE. The remaining

$$2 {LM}_{v} - {K}_{l}^{NZ}$$

non-reported coefficients are considered zero.
   K₀=┌β×2LM₁┐ is the maximum number of non-zero coefficients per layer, where β is a RRC configured parameter. Supported β values are shown in Table 1.
   For v∈{2, 3, 4}, the total number of non-zero coefficients summed across all layers,

$${K}^{NZ} = {\sum }_{l = 1}^{v} {K}_{l}^{NZ} ,$$

shall satisfy K^{NZ}≤2K₀.
Selected coefficient subset for each layer is indicated with

$${K}_{l}^{NZ}$$

in a size 2LMᵥ bitmap, i_{1,7,l}.
The strongest coefficient of layer l (whose amplitude and phase are not reported) is identified by i_{1,8,l},∈{0,1, . . . , 2L−1}.
The amplitude coefficients in \tilde{W}_{2,l} are indicated by i_{2,5,l} and i_{2,4,l}, and the phase coefficients in \tilde{W}_{2,l} are indicated by i_{2,5,l}.

The above is described in TS38.214 V15.16.0, section 5.2.2.2.5, where

$${w}_{l}^{( t )}$$

is expressed as follows:

$${W}_{{q}_{1} , {q}_{2} , {n}_{1} , {n}_{2} , {n}_{3 , l} , {p}_{l}^{( 1 )} , {p}_{l}^{( 2 )} , {i}_{2 , 5 , l} , t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{v} - 1} {y}_{t , l}^{( f )} {p}_{l , i + L , f}^{( 2 )} {φ}_{l , i + L , f}\end{matrix} ] , l = 1 , 2 , 3 , 4 ,$$

$${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{v} - 1} {y}_{t , l}^{( f )} {p}_{l , i , f}^{( 2 )} {φ}_{l , i , f} \vert}^{2}$$

where

$$\{ {q}_{1} , {q}_{2} , {n}_{1} , {n}_{2} , {n}_{3 , l} , {p}_{l}^{( 1 )} , {p}_{l}^{( 2 )} , {i}_{2 , 5 , l} \}$$

are quantities reported by a UE and
{₁,q₂} are reported via the parameter i_{1,1} while {n₁,n₂} are reported via the parameter

$${n}_{3 , l} = [ {n}_{3 , l}^{( 0 )} , ... , {n}_{3 , l}^{( {M}_{v} - 1 )} ] , {n}_{3 , l}^{( f )} ∈ \{ 0 , 1 , ... , {N}_{3} - 1 \} ,$$

are the indices of the M_{ν} FD basis vectors

$$\{ {y}_{l}^{( 0 )} , {y}_{l}^{( 1 )} , ... , {y}_{l}^{( {M}_{v} - 1 )} \}$$

$${p}_{l}^{( 1 )} = [ \begin{matrix}{p}_{l , 0}^{( 1 )} & {p}_{l , 1}^{( 1 )}\end{matrix} ]$$

are the wideband amplitudes of the coefficients {\tilde{w}_{l,i,f}} at two polarizations, and

$${p}_{l , i , f}^{( 2 )}$$

is the subband amplitude of the coefficient \tilde{w}_{l,i,f}, where

$${p}_{l , i , f}^{( 2 )}$$

is part of

$${p}_{l}^{( 2 )} = [ {p}_{l , 0}^{( 2 )} ... {p}_{l , {M}_{v} - 1}^{( 2 )} ] , {p}_{l , f}^{( 2 )} = [ {p}_{l , 0 , f}^{( 2 )} ... {p}_{l , 2 L - 1 , f}^{( 2 )} ] ,$$

$${φ}_{l , i , f} = {e}^{j \frac{2 π {c}_{l , i , f}}{16}}$$

is phase coefficient of \tilde{w}_{l,i,f}, where c_{l,i,f}∈{0, . . . , 15} is part of i_{2,5,l}=[c_{l,0} . . . c_{l,M}_{_{ν}}₋₁], c_{l,f}=[c_{l,0,f} . . . c_{l,2L-1,f}]

TABLE 1
Codebook parameter configurations for L, β and
p_{υ} for Rel-16 enhanced type II codebook

| | |
|---|---|
| paramCombination- | p_{υ} |

| r16 | L | υ ∈ {1, 2} | υ ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

### I. NR Rel-16 Enhanced Type II Port Selection Codebook

The enhanced Type II (eType II) port selection (PS) codebook was also introduced in Rel-16, which is intended to be used for beamformed CSI-RS, i.e., each CSI-RS port corresponds to a 2D spatial beam. Based on the measurement, the UE selects the best CSI-RS ports and recommends a rank, a precoding matrix, and a CQI conditioned on the rank and the precoding matrix to the gNB.

The precoding matrix comprises linear combinations of the selected CSI-RS ports. For a given transmission layer l, with l∈{1, . . . , v} and v being the rank indicated by the rank indicator (RI), the precoder matrix has the same form as Rel16 enhanced Type II codebook, i.e.

$${W}_{l} = [ {w}_{l}^{( 0 )} ... {w}_{l}^{( {N}_{3} - 1 )} ] = {W}_{1} {\tilde{W}}_{2 , l} {W}_{f , l}^{H} ,$$

\tilde{W}_{2,l} and W_{f,l} are the same as in Rel-16 enhanced Type II codebook. The main difference is on W₁, which is a size P_{CSI-RS}×2L port selection matrix given by

$${W}_{1} = [ \begin{matrix}{e}_{{m}^{( 0 )}} , ... , {e}_{{m}^{( L - 1 )}} & 0 \\ 0 & {e}_{{m}^{( 0 )}} , ... , {e}_{{m}^{( L - 1 )}}\end{matrix} ] ,$$

where eₘ₍ᵢ₎=[0, . . . , 0,1,0, . . . , 0]^{T}, i=0,1, . . . , L−1, is a port selection vector of size

$$\frac{{P}_{CSI - RS}}{2} \times 1$$

and contains one element with value of one at location

$${m}^{( i )} ∈ \{ 0 , 1 , ... , ⌈ \frac{{P}_{CSI - RS}}{2 d} ⌉ - 1 \}$$

indicating the selected CSI-RS port while all the other elements are with values of zero, e.g., e₀=[1,0, . . . , 0]^{T} and e_{P}_{_{CSI-RS/2}}=[0,0, . . . , 0,1]^{T}. L is the number of selected CSI-RS ports from each polarization and the same ports are selected for both polarizations. Supported L values can be found in Table 2. The value of d is configured with the higher layer parameter portSelectionSamplingSize, where d∈{1, 2, 3, 4} and

$$d < min ( \frac{{P}_{CSI - RS}}{2} , L ) .$$

Selected CSI-RS ports are indicated by

$${i}_{1 , 1} ∈ \{ 0 , 1 , ... , ⌈ \frac{{P}_{CSI - RS}}{2 d} ⌉ - 1 \} ,$$

which is reported by the UE to gNB. i_{1,2} is irrelevant and thus is not reported.

TABLE 2
Codebook parameter configurations for L, β and p_{υ} for Rel-
16 enhanced port selection type II codebook.

| | |
|---|---|
| paramCombination- | p_{υ} |

| r16 | L | υ ∈ {1, 2} | υ ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |

For Rel-16 Enhanced Type II CSI feedback, a CSI report comprises of two parts. Part 1 has a fixed payload size and is used to identify the number of information bits in Part 2. Part 1 contains RI, CQI, and an indication of the overall number of non-zero amplitude coefficients across layers, i.e.,

$${K}_{tot}^{NZ} ∈ \{ 1 , 2 , … , 2 {K}_{0} \} .$$

Part 2 contains the PMI. Part 1 and 2 are separately encoded.

### J. NR Rel-17 Further Enhanced Type II Port Selection Codebook

The Rel-16 port selection codebook is further enhanced in Rel-17, in which it is assumed that each CSI-RS port is associated to a channel delay and different channel delays are associated to different CSI-RS ports. It is also assumed that the delays associated to the CSI-RS ports have been pre-compensated before being transmitted and thus, only one or two frequency domain basis vectors may be selected by a UE, i.e., Mᵥ∈{1,2}. The one or two FD basis vectors are the same for all layers, therefore M is used instead of Mᵥ.

The L CSI-RS ports or beams at each polarization to be selected is indirectly configured as L=αP_{CSI-RS}/2, where parameter a is configured by RRC as shown in Table 3. The 2L total CSI-RS ports are selected from P_{CSI-RS} ports based on L port selection vectors eₘ₍ᵢ₎, i=0,1, . . . , L−1, which are identified by:

$$m = [ {m}^{( 0 )} … {m}^{( L - 1 )} ]$$

$${m}^{( i )} ∈ \{ 0 , 1 , … , \frac{{P}_{CSI}}{2} - 1 \}$$

which are indicated by the index i_{1,2}, where:

$${i}_{1 , 2} ∈ \{ 0 , 1 , … , ( \begin{matrix}{P}_{CSI} / 2 \\ L\end{matrix} ) - 1 \} .$$

The M selected FD basis vectors

$${[ {y}_{0}^{( f )} , {y}_{1}^{( f )} , … , {y}_{{N}_{3} - 1}^{( f )} ]}^{T} , f ∈ \{ 0 , … , M - 1 \} ,$$

are identified by n₃, and where:

$${n}_{3} = [ {n}_{3}^{( 0 )} … {n}_{3}^{( M - 1 )} ]$$

$${n}_{3}^{( f )} ∈ \{ \begin{matrix}\{ 0 \} & M = 1 \\ \{ 0 , 1 , … , min ( N , {N}_{3} ) - 1 \} & M = 2\end{matrix}$$

with the indices f∈{0, . . . , M−1} assigned such that

$${n}_{3}^{( f )}$$

increases with f. n₃ is indicated by the index i_{1,6}.

TABLE 3
Codebook parameter configurations for α, M and β for
Rel-17 further enhanced type II port selection codebook

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

K. 2.1.11 Coherent Joint PDSCH Transmission from Multiple TRPs

In NR Rel-18, it has been agreed to support coherent joint downlink transmission (CJT) from multiple transmission and reception points (TRPs) by extending Rel-16 and Rel-17 enhanced type II codebook across multiple TRPs. In the case of CJT, each layer of a PDSCH is transmitted from multiple TRPs. An example is shown in FIG. 4, where a PDSCH 406 with two layers are transmitted from two TRPs 402 and 404 by applying two different precoding matrices 408 and 410 to the PDSCH 406 at TRP1 and TRP2. The two precoders 408 and 410 are designed such that for each layer, the signals received from the two TRPs 402 and 404 are phase aligned at the UE 412 and thus, are coherently combined at the UE 412.

There currently exist certain challenge(s). One of the configuration parameters in all Rel-15 to Rel-17 type II codebooks and their extensions to CJT is the number of spatial beams, L, to be selected by a UE for PMI feedback. Note that in the case of port selection codebooks, L is related to the number of CSI-RS ports selected by the UE (i.e., the number of CSI-RS ports selected is given by 2L). Linear combining coefficients of the L beams are reported for each MIMO layer and for each PMI sub-band.

In Rel-16 enhanced type II CB and type II port selection CB, L∈{2,4,6} with the following restrictions:
L=2 when P_{CSI-RS}=4;
L∈{2,4} when 4<P_{CSI-RS}<32; and
L∈{2,4,6} when P_{CSI-RS}=32.

When the legacy Rel-16 and Rel-17 type II CBs are extended to DL CJT over multiple TRPs in Rel-18, it is envisioned that multiple CSI-RS resources or multiple antenna port groups in a single CSI-RS resource will be configured, where CSI-RS ports in each resource or antenna port group are transmitted from one of the multiple TRPs and L spatial beams over the multiple CSI-RS resources may be configured.

In one approach, L can be dependent on the aggregated number of CSI-RS ports across all the CSI-RS resources.

However, following this approach, if there are three TRPs and three CSI-RS resources are configured each with two CSI-RS ports, the aggregated number of CSI-RS ports is P_{CSI-RS}=6, which is however not a CSI-RS port number supported in legacy type II CB.

Alternatively, L may be configured per CSI-RS resource or per antenna port group. Then, the total number of selected beams would be an aggregation of the beams configured for all the resources or antenna port groups. However, this means a UE has to report L spatial beams for each TRP even though a TRP may not be good for participating in CJT, e.g., due to very weak signal from the TRP, and thus, unnecessary overhead is introduced.

Thus, clearly, how to configure/report the number of spatial beams or the number of CSI-RS ports to be selected is a problem for extending legacy type II CB to multi-TRP for coherent joint DL transmission.

### SUMMARY

The present disclosure relates to a method for reducing the Type II Channel State Information (CSI) reporting overhead when it is used for coherent joint transmission (CJT) to a User Equipment device (UE) from multiple transmission/reception points (TRPs) where some of the TRPs are not suitable for CJT to the UE. The network node can configure a UE with CSI reference signals (CSI-RS) resources each associated to respective TRPs. The UE can measure the channels and send a CSI report back to the network node that includes CSI measurements. The CSI report can also include a number of selected spatial beams for each CSI-RS resource of the CSI-resources. The CSI report may also include a number of Frequency Domain (FD) basis vectors selected based on a number of CSI-RS resources from which at least one beam or port are selected.

In an embodiment, a method performed by a UE for reducing CSI reporting overhead for CJT from multiple TRPs is provided. The method can include receiving configuration from a network node with a type-II Codebook (CB) based CSI report configuration comprising N_{RS} CSI Reference Signal, CSI-RS, resources each associated to one of the multiple TRPs and a maximum total number of L spatial beams comprised in the CSI for CJT. The method can also include receiving a transmission comprising the N_{RS} CSI-RS resources and a request to report the type-II CB based CSI according to the CSI Report configuration. The method can also include measuring channels based on the N_{RS} CSI-R resources and calculating a CSI based on an aggregation of the measured channels by selecting L′ spatial beams, where L′ is an integer and is smaller than or equal to L and determining numbers of selected spatial beams for each N_{RS} CSI-RS resource of the N_{RS} CSI-RS resources. The method can include transmitting the CSI report comprising beam indices for each of the L′ spatial beams and wherein a first part of the CSI report also comprises the numbers of selected spatial beams for each N_{RS} CSI-RS resource of the N_{RS} CSI-RS resources.

In another embodiment, a UE that comprises a memory that stores computer-executable instructions and a processor that executes the computer-executable instruction to perform operations can be provided. The operations can include receiving configuration from a network node with a type-II CB based CSI report configuration comprising N_{RS} CSI Reference Signal, CSI-RS, resources each associated to one of the multiple TRPs and a maximum total number of L spatial beams comprised in the CSI for CJT. The operations can also include receiving a transmission comprising the N_{RS} CSI-RS resources and a request to report the type-II CB based CSI according to the CSI Report configuration. The operations can also include measuring channels based on the N_{RS} CSI-R resources and calculating a CSI based on an aggregation of the measured channels by selecting L′ spatial beams, where L′ is an integer and is smaller than or equal to L and determining numbers of selected spatial beams for each N_{RS} CSI-RS resource of the N_{RS} CSI-RS resources. The operations can include transmitting the CSI report comprising beam indices for each of the L′ spatial beams and wherein a first part of the CSI report also comprises the numbers of selected spatial beams for each N_{RS} CSI-RS resource of the N_{RS} CSI-RS resources.

In an embodiment, a method performed by a UE for reducing CSI reporting overhead for CJT from multiple TRPs can be provided. The method can include receiving configuration from a network node with a type-II CB based CSI report configuration comprising N_{RS} CSI-RS resources each associated to one of the multiple TRPs and a maximum total number of L spatial beams comprised in the CSI for CJT. The method can include receiving a transmission comprising the N_{RS} CSI-RS resources and a request to report the type-II CB based CSI according to the CSI Report configuration. The method can include measuring channels based on the N_{RS} CSI-RS resources and calculating a CSI based on an aggregation of the measured channels by selecting L′ spatial beams, where L′ is an integer and is smaller than or equal to L. The method can include determining a number of FD basis vectors selected based on a number of CSI-RS resources from which at least one beam or port are selected. The method can also include transmitting the CSI report comprising beam indices for each of the L′ spatial beams, wherein a second part of the CSI report comprises the number of FD basis vectors.

In another embodiment, a UE that comprises a memory that stores computer-executable instructions and a processor that executes the computer-executable instruction to perform operations can be provided. The operations can include receiving configuration from a network node with a type-II CB based CSI report configuration comprising N_{RS} CSI-RS resources each associated to one of the multiple TRPs and a maximum total number of L spatial beams comprised in the CSI for CJT. The operations can include receiving a transmission comprising the N_{RS} CSI-RS resources and a request to report the type-II CB based CSI according to the CSI Report configuration. The operations can include measuring channels based on the N_{RS} CSI-RS resources and calculating a CSI based on an aggregation of the measured channels by selecting L′ spatial beams, where L′ is an integer and is smaller than or equal to L. The operations can include determining a number of FD basis vectors selected based on a number of CSI-RS resources from which at least one beam or port are selected. The operations can also include transmitting the CSI report comprising beam indices for each of the L′ spatial beams, wherein a second part of the CSI report comprises the number of FD basis vectors.

In an embodiment, a method is provided that is performed by one or more network nodes for reducing CSI reporting overhead for CJT to a UE from multiple TRPs. The method includes configuring the UE with a type-II CB based CSI report configuration comprising N_{RS} CSI Reference Signal, CSI-RS, resources each associated to one of the multiple TRPs and a parameter L, which specifying a maximum number of spatial beams comprised in the CSI for CJT. The method includes transmitting the N_{RS} CSI-RS resources and requesting that the UE reports the type-II CB based CSI according to the CSI Report configuration. The method includes receiving, from the UE a CSI report comprising CSI associated with L′ spatial beams, where L′ is an integer and is smaller than or equal to L wherein a first part of the CSI report also comprises a numbers of selected spatial beams for each N_{RS} CSI-RS resource of the N_{RS} CSI-RS resources. The method includes constructing a precoding matrix for each of the multiple TRPs based on the CSI report and applying the precoding matrix to a Physical Downlink Shared Channel (PDSCH) at each of the multiple TRPs.

In an embodiment, a network node is provided that includes a memory that stores computer-executable instructions and a processor that executes the computer-executable instruction to perform operations. The operations include configuring the UE with a type-II Codebook, CB, based CSI report configuration comprising N_{RS} CSI Reference Signal, CSI-RS, resources each associated to one of the multiple TRPs and a parameter L, which specifying a maximum number of spatial beams comprised in the CSI for CJT. The operations includes transmitting the N_{RS} CSI-RS resources and requesting that the UE reports the type-II CB based CSI according to the CSI Report configuration. The operations includes receiving, from the UE a CSI report comprising CSI associated with L′ spatial beams, where L′ is an integer and is smaller than or equal to L wherein a first part of the CSI report also comprises a numbers of selected spatial beams for each N_{RS} CSI-RS resource of the N_{RS} CSI-RS resources. The operations includes constructing a precoding matrix for each of the multiple TRPs based on the CSI report and applying the precoding matrix to a PDSCH, at each of the multiple TRPs.

In another embodiment, a method is provided that is performed by one or more network nodes for reducing CSI reporting overhead for CJT to a UE from multiple TRPs. The method includes configuring the UE with a type-II CB based CSI report configuration comprising N_{RS} CSI Reference Signal, CSI-RS, resources each associated to one of the multiple TRPs and a parameter L, which specifying a maximum number of spatial beams comprised in the CSI for CJT. The method includes transmitting the N_{RS} CSI-RS resources and requesting that the UE reports the type-II CB based CSI according to the CSI Report configuration. The method includes receiving from the UE, a CSI report comprising CSI associated with L′ spatial beams, where L′ is an integer and is smaller than or equal to L, wherein a second part of the CSI report comprises a number of FD basis vectors selected based on a number of CSI-RS resources from which at least one beam or port are selected. The method includes constructing a precoding matrix for each of the multiple TRPs based on the CSI report and applying the precoding matrix to a PDSCH, at each of the multiple TRPs.

In an embodiment, a network node is provided that includes a memory that stores computer-executable instructions and a processor that executes the computer-executable instruction to perform operations. The operations include configuring the UE with a type-II CB based CSI report configuration comprising N_{RS} CSI Reference Signal, CSI-RS, resources each associated to one of the multiple TRPs and a parameter L, which specifying a maximum number of spatial beams comprised in the CSI for CJT. The operations includes transmitting the N_{RS} CSI-RS resources and requesting that the UE reports the type-II CB based CSI according to the CSI Report configuration. The operations includes receiving, from the UE, a CSI report comprising CSI associated with L′ spatial beams, where L′ is an integer and is smaller than or equal to L, wherein a second part of the CSI report comprises a number of FD basis vectors selected based on a number of CSI-RS resources from which at least one beam or port are selected. The operations includes constructing a precoding matrix for each of the multiple TRPs based on the CSI report and applying the precoding matrix to a PDSCH, at each of the multiple TRPs.

Certain embodiments may provide one or more of the following technical advantage(s). The proposed solution reduces the Type II CSI reporting overhead when it is used for coherent joint transmission to a UE from multiple TRPs where some of the TRPs are not suitable for CJT to the UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shown an example of spatial multiplexing according to an embodiment of the present disclosure;

FIG. 2 shows an example of a 4×4 array with dual-polarized antenna elements according to an embodiment of the present disclosure;

FIG. 3 shows an example of channel state information (CSI) resource elements for 12 antenna ports according to an embodiment of the present disclosure;

FIG. 4 shows an example of coherent joint transmission (CJT) according to an embodiment of the present disclosure;

FIG. 5 shows an example of coherent joint transmission to a user equipment device (UE) from multiple transmission/reception points (TRPs) according to an embodiment of the present disclosure;

FIG. 6 is a flowchart of a method performed by a network node for reducing CSI reporting overhead for CJT to a UE from multiple TRPs according to an embodiment of the present disclosure;

FIG. 7 is a flowchart of a method performed by a UE for reducing CSI reporting overhead for CJT from multiple TRPs according to an embodiment of the present disclosure according to an embodiment of the present disclosure;

FIG. 8 shows an example of a communication system according to an embodiment of the present disclosure;

FIG. 9 shows a UE according to an embodiment of the present disclosure;

FIG. 10 shows a network node according to an embodiment of the present disclosure;

FIG. 11 is a block diagram of a host according to an embodiment of the present disclosure;

FIG. 12 is a block diagram illustrating a virtualization environment in which functions implemented by some embodiments may be virtualized according to an embodiment of the present disclosure; and

FIG. 13 shows a communication diagram of a host communicating via a network node with a UE over a partially wireless connection according to an embodiment of the present disclosure.

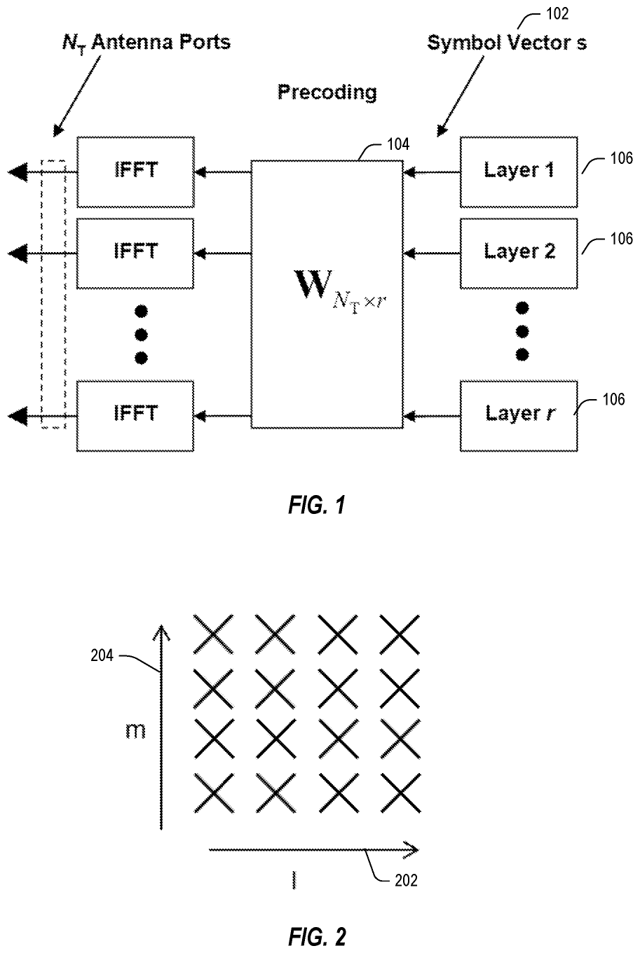

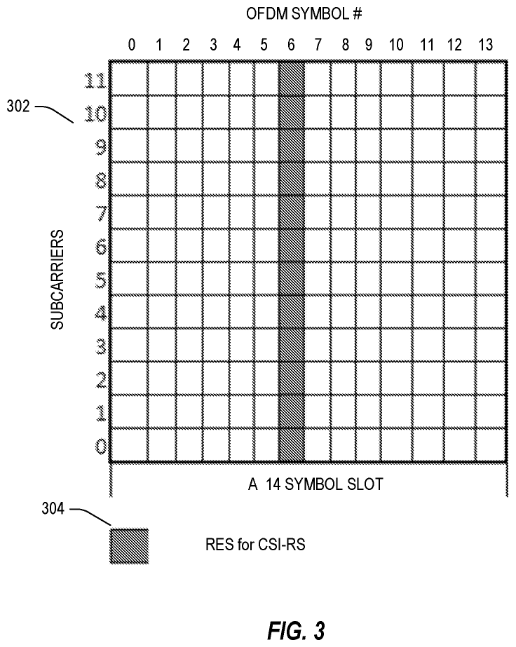

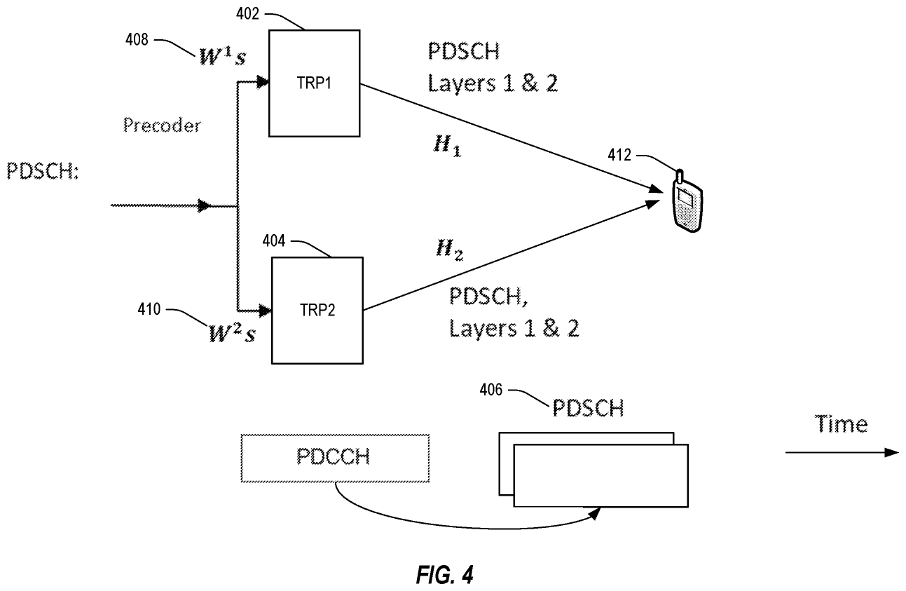

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Certain aspects of the disclosure and their embodiments may provide solutions to the challenges described above. A method for configuring L spatial beams for Rel-16 type II codebook (CB) or 2L ports for Rel-17 type II port selection CB based Channel State Information (CSI) feedback for downlink (DL) Coherent Joint Transmission (CJT) transmission. The method comprises:
Configure L (L=2,3,4,6,8) spatial beams or ports for up to N_{RS} CSI Reference Signal (CSI-RS) resources.
User equipment (UE) measures channel based on the CSI-RS resources and selects L′=

$${L}^{′} = {\sum }_{s = 1}^{{N}_{RS}} {L}_{s}$$

spatial beams or ports for CJT CSI calculation, where L′≤L and Lₛ is the selected beams or ports associated with the s^{th} CSI-RS resource.
UE reports L′ or {Lₛ, s=1, . . . , N_{RS}} together with rank and Channel Quality Indicator (CQI) in Part 1 of a corresponding CSI report. If Lₛ=0, it indicates that the associated s^{th} CSI-RS resource or Transmission/Reception Point (TRP) is note selected for CJT.
UE reports per TRP beam selection, i.e., Lₛ selected beams for the s^{th} CSI-RS resource, and if Lₛ=0, the associated s^{th} CSI-RS resource or TRP is not selected for CJT.
UE reports per TRP port selection, i.e., 2Lₛ selected CSI-RS ports for the s^{th} CSI-RS resource, and if Lₛ=0, the associated s^{th} CSI-RS resource or TRP is not selected for CJT.
UE may select and report a smaller number of spatial beams than configured number of beams, i.e., L′<=L. L′ or {Lₛ, s=1, . . . , N_{RS}} is reported together with rank and CQI in Part 1 of the CSI report.

Certain embodiments may provide one or more of the following technical advantage(s). The proposed solution reduces the Type II CSI reporting overhead when it is used for coherent joint transmission to a UE from multiple TRPs where some of the TRPs are not suitable for CJT to the UE.

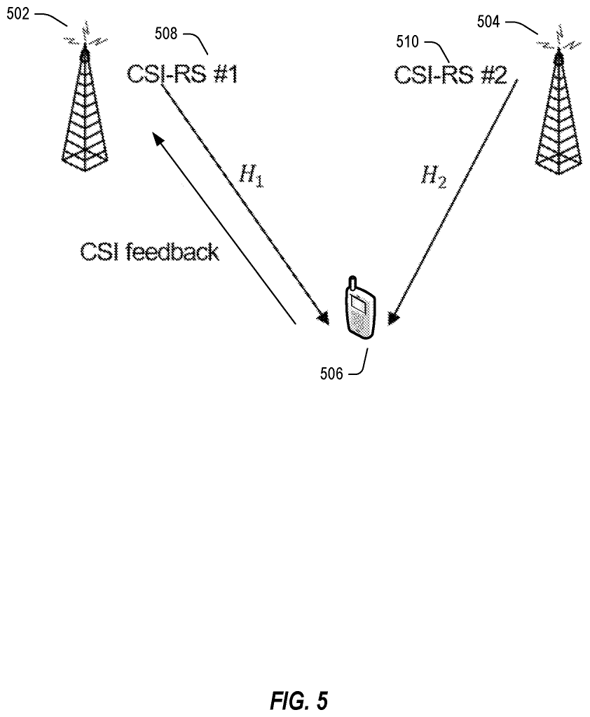

An example is shown in FIG. 5, where two CSI-RS resources 508 and 510 (i.e., N_{RS}=2), CSI-RS #1 and CSI-RS #2, each containing a number of CSI-RS ports, are configured and transmitted from two TRPs 502 and 504 to a UE 506.

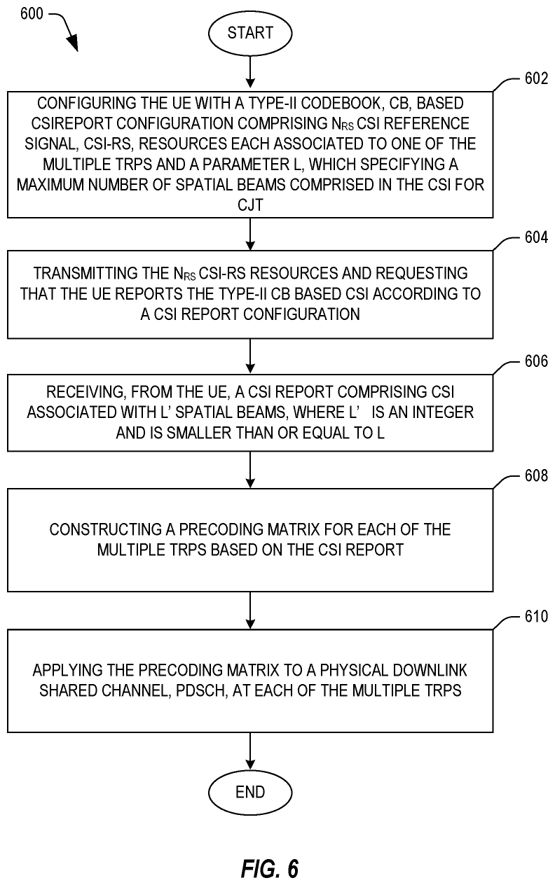

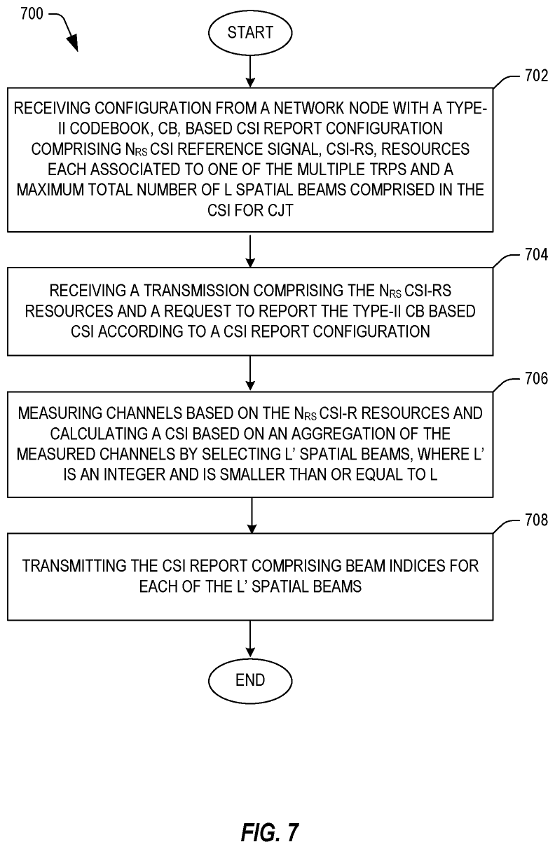

A general procedure of the proposed Type II CSI reporting enhancement for multi-TRP coherent joint transmission can be summarized by the methods 600 and 700 in FIGS. 6 and 7.

Method 600 can begin at step 602 where the method includes configuring the UE 506 with a Type-II CB based CSI Report comprising N_{RS} CSI-RS resources and L spatial beams for CJT.

Note that in some alternative embodiments, a single CSI-RS resource may be configured with a first subset of CSI-RS ports (also referred to as a first CSI-RS port group or a first antenna port group) associated with a first TRP and a second subset of ports (also referred to as a second CSI-RS port group or a second antenna port group) associated with a second TRP. Even though the embodiments described henceforth in this disclosure cover the case of multiple CSI-RS resources, these embodiments are equally applicable to the case of a single CSI-RS resource with multiple CSI-RS port groups. To apply the embodiments to the single CSI-RS resource case, the sth CSI-RS resource in the description of the embodiments is replaced by the sth CSI-RS port group.

A UE 506 may be configured with L=2,3,4,6,8 spatial beams for Type II CSI report with up to four CSI-RS resources. Some constraints may be applied for L such that L is equal or smaller than half of the aggregated number of CSI-RS ports across the configured CSI-RS resource. For example,
L≤4 for two CSI-RS resources each with four CSI-RS ports,
L≤6 for three CSI-RS resources each with four CSI-RS ports,

In another scenario, L may be configured as L=N_{RS}L₀, where L₀ is number of beams per CSI-RS resource or TRP. The possible candidate values for L₀ can be 1, 2, and 4.

For Rel-17 type II port selection codebook, L represents the CSI-RS ports for each polarization where L is not directly configured. Instead, it is configured via a scaling parameter

$$α ( α ∈ \{ 1 , \frac{3}{4} , \frac{1}{2} \} )$$

such that L=αP_{CSI-RS}/2. To extend the Rel-17 type II port selection codebook based CSI feedback for DL CJT, in one embodiment, a single a parameter is configured which is applied to all N_{RS} CSI-RS resources configured in order to determine the total number of selected ports. That is, Lₛ=αP_{CSI-RS,s}/2 wherein 2Lₛ ports are selected from the sth (s=1, . . . , N_{RS}) CSI-RS resource, and

In another embodiment, αₛ (s=1, . . . , N_{RS}) is configured per CSI-PR resource. 2Lₛ ports are selected from the sth (s=1, . . . , N_{RS}) CSI-RS resource where Lₛ=αₛP_{CSI-RS,s}/2

In step 604, the network nodes or TRPs 502 or 504 transmit N_{RS} CSI-RS resources and requesting that the UE 506 reports the type-II CB based CJT CSI according to the CSI Report configuration in step 602.

The UE 506 will then obtain an aggregated DL channel \tilde{H}=[H₁, . . . , \tilde{H}_{N}_{_{RS}}] from the individual per TRP channel estimation \tilde{H}ₛ (s=1,2, . . . , N_{RS}), based on the sth CSI-RS resource. The sth CSI-RS resource is according to the order the resource is configured in the CSI report configuration in step 602. For example, if two CSI-RS resources are configured as {CSI-RS resource #x, CSI-RS resource #y} for the CJT CSI report, the first CSI-RS resource (i.e., s=1) is CSI-RS resource #x and the 2nd CSI-RS resource (i.e., s=2) is CSI-RS resource #y.

If different Physical Downlink Shared Channel (PDSCH) to CSI-RS power offsets are configured for different CSI-RS resources, the channel measured on each of the CSI-RS resources need to be scaled according to the configured power offset before forming the aggregated channel. For example, if a power offset of −3 dB is configured for a CSI-RS resource, the measured channel based on the CSI-RS resource needs to be scaled by

$$\frac{1}{\sqrt[2]{2}} .$$

The UE 506 calculates a Type II Precoding Matric Indicator (PMI) based on the aggregated DL channel \tilde{H}. It is assumed that the UE 506 is configured with a set of parameters for the CJT CSI report in step 602 as follows:
L: the total number of spatial beams across all CSI-RS resources or TRP
R∈{1,2}: a scaling factor for PMI subband size
pᵥ: a parameter used to configure the number Frequency Domain (FD) basis vectors for a given rank v, i.e.,

$${M}_{v} = ⌈ {p}_{v} \frac{{N}_{3}}{R} ⌉ ,$$

where N₃=N_{CQI}R and N_{CQI} is a number of CQI subbands
β: a parameter used to configure the maximum number of non-zero coefficients (NZCs), i.e., K₀=┌β2LM₁┐, for each layer. The total number of NZCs across all layers, K^{NZ}≤2K₀

For MIMO layer l, the precoder matrix Wₗ across all TRPs is given by a size P_{CSI-RS}×N₃ matrix:

$${W}_{l} = [ {w}_{l}^{( 0 )} … {w}_{l}^{( {N}_{3} - 1 )} ] = {W}_{1} {\tilde{W}}_{2 , l} {W}_{f , l}^{H} , \qquad Eq . 1$$

### Where:

$${w}_{l}^{( t )}$$

is a P_{CSI-RS}×1 precoding vector at a subband with subband index t∈{0,1, . . . , N₃−1} for layer l, where

$${P}_{CSI - RS} = {\sum }_{s = 1}^{{N}_{RS}} {P}_{CSI - RS , s}$$

is the total number of CSI-RS ports in all the N_{RS} NZP CSI-RS resources, P_{CSI-RS,s}=2N_{1,s}N_{2,s} is the number of CSI-RS ports in the sth NZP CSI-RS resource, where N_{1,s} and N_{2,s} are the number of antenna ports in a first and a second dimensions. Note that the number of CSI-RS ports in different NZP CSI-RS resources may be same or different.

$${W}_{1} = diag ( {W}_{1}^{( 1 )} , … , {W}_{1}^{( {N}_{RS} )} )$$

is a size P_{CSI-RS}×2L′ block diagonal spatial matrix, where L′ is the total number of selected spatial beams associated with all the N_{RS} NZP CSI-RS resources

$${W}_{1}^{( s )} = [ \begin{matrix}{v}_{{m}_{1}^{( 0 )} , {m}_{2}^{( 0 )}}^{( s )} , … , {v}_{{m}_{1}^{( {L}_{s} - 1 )} , {m}_{2}^{( {L}_{s} - 1 )}}^{( s )} & 0 \\ 0 & {v}_{{m}_{1}^{( 0 )} , {m}_{2}^{( 0 )}}^{( s )} , … , {v}_{{m}_{1}^{( {L}_{s} - 1 )} , {m}_{2}^{( {L}_{s} - 1 )}}^{( s )}\end{matrix} ]$$

is a size P_{CSI-RS,s}×2Lₛ precoding matrix associated with the s^{th} NZP CSI-RS resource, s=1, . . . , N_{RS} and

$${L}^{′} = {\sum }_{s = 1}^{{N}_{RS}} {L}_{s} .$$

$$\{ {v}_{{m}_{1 , s}^{( 0 )} , {m}_{2 , s}^{( 0 )}}^{( s )} , … , {v}_{{m}_{1 , s}^{( {L}_{s} - 1 )} , {m}_{2 , s}^{( {L}_{s} - 1 )}}^{( s )} \}$$

is a set of size P_{CSI-RS,s}/2×1 selected 2-D DFT beams

$${v}_{{m}_{1 , s}^{( i )} , {m}_{2 , s}^{( i )}}^{( s )} = {[ {u}_{{m}_{2}^{( i )}}^{( s )} , {e}^{j \frac{2 π {m}_{1 , s}^{( i )}}{{O}_{1 , s} {N}_{1 , s}}} {u}_{{m}_{2}^{( i )}}^{( s )} , … , {e}^{j \frac{2 π {m}_{1 , s}^{( i )} ( {N}_{1 , s} - 1 )}{{O}_{1 , s} {N}_{1 , s}}} {u}_{{m}_{2}^{( i )}}^{( s )} ]}^{T}$$

$${u}_{{m}_{2}^{( i )}}^{( s )} = {[ 1 , {e}^{j \frac{2 π {m}_{2}^{( i )}}{{O}_{2 , s} {N}_{2 , s}}} , … , {e}^{j \frac{2 π {m}_{2}^{( i )} ( {N}_{2 , s} - 1 )}{{O}_{2 , s} {N}_{2 , s}}} ]}^{T} if$$

$${N}_{2 , s} > 1 and {u}_{{m}_{2}^{( i )}}^{( s )} = 1 if {N}_{2 , s} = 1$$

$${m}_{1 , s}^{( i )} = {O}_{1 , s} {n}_{1 , s}^{( i )} + {q}_{1 , s} , {m}_{2 , s}^{( i )} = {O}_{2 , s} {n}_{2 , s}^{( i )} + {q}_{2 , s} , {n}_{1 , s}^{( i )} ∈ \{ 0 , 1 , … , {N}_{1 , s} - 1 \} ,$$

$${n}_{2 , s}^{( i )} ∈ \{ 0 , 1 , … , {N}_{2 , s} - 1 \} , {q}_{1 , s} ∈ \{ 0 , 1 , … , {O}_{1 , s} - 1 ) ,$$

$${q}_{2 , s} ∈ \{ 0 , 1 , … , {O}_{2 , s} - 1 ) , i = 0 , 1 , … {L}_{s} - 1 ,$$

and O_{1,s} and O_{2,s} are the oversampling factors along dimensions of N_{1,s} and N_{2,s}, respectively.
If port selection type II CSI is configured, then each of the CSI-RS ports in all the CSI-RS resources corresponds to 2-D spatial beam and

$${W}_{1}^{( s )} = [ \begin{matrix}{e}_{{m}_{s}^{( 0 )}}^{( s )} , … , {e}_{{m}_{s}^{( {L}_{s} - 1 )}}^{( s )} & 0 \\ 0 & {e}_{{m}_{s}^{( 0 )}}^{( s )} , … , {e}_{{m}_{s}^{( {L}_{s} - 1 )}}^{( s )}\end{matrix} ] ,$$

where

$${e}_{{m}^{( i )}}^{( s )} ( i = 0 , 1 , … , {L}_{s} - 1 )$$

is a P_{CSI-RS,s}/2×1 containing a value of 1 in the element of index

$${m}_{s}^{( i )}$$

and zeros elsewhere where the first element is the element of index 0

$${m}_{s}^{( i )} ∈ \{ 0 , 1 , … , \frac{{P}_{CSI - RS , s}}{2} - 1 \}$$

$${W}_{f , l} = [ {y}_{l}^{( 0 )} , {y}_{l}^{( 1 )} , … , {y}_{l}^{( {M}_{v} - 1 )} ]$$

is a size-N₃×Mᵥ frequency domain (FD) compression matrix comprising Mᵥ selected FD basis vectors, where

$${y}_{l}^{( f )} ∈ \{ {y}_{0} {y}_{1} … {y}_{{N}_{3} - 1} \} ,$$

and yₖ=[y_{k,0}, y_{k,1}, . . . , y_{k,N}_{₃}₋₁] and y_{k,t}=e^{j2kt/N}^{₃}, k,t=0, 1, . . . , N₃−1. W_{f,l} is common for all CSI-RS resources or TRPs

$${\tilde{W}}_{2 , l} = [ \begin{matrix}{\tilde{W}}_{2 , l , 1} \\ ⋯ \\ {\tilde{W}}_{2 , l , {N}_{RS}}\end{matrix} ] = [ {c}_{l , i , f} , i = 0 , 1 , … , 2 {L}^{′} - 1 , f = 0 , 1 , … , {M}_{v} - 1 ]$$

is a size 2L′×Mᵥ coefficient matrix
N₃ is the number of PMI subbands, common for all CSI-RS resources or TRPs

In an alternative expression, each of the precoding vector

$${w}_{l}^{( t )}$$

can be expressed as follows:

$${w}_{l}^{( t )} = {γ}_{l} [ \begin{matrix}\begin{matrix}{w}_{1 , l}^{( t )} \\ ⋯\end{matrix} \\ {w}_{{N}_{RS} , l}^{( t )}\end{matrix} ] , l = 1 , … , v , \qquad Eq . 2$$

$${w}_{s , l}^{( t )} = [ \begin{matrix}{w}_{s , l , 0}^{( t )} \\ {w}_{s , l , 1}^{( t )}\end{matrix} ] , s = 1 , … , {N}_{RS} . \qquad Eq . 3$$

$${w}_{s , l , p}^{( t )} = {\sum }_{i = 0}^{{L}_{s} - 1} {v}_{{m}_{1 , s}^{( i )} , {m}_{2 , s}^{( i )}}^{( s )} {\sum }_{f = 0}^{{M}_{ν} - 1} {c}_{l , i , f , p , s} {y}_{t , l}^{( f )} , p = 0 , 1 \qquad Eq . 4$$

$${y}_{t , l}^{( f )} = {e}^{j \frac{2 π {tn}_{3 , l}^{( f )}}{{N}_{3}}} , \qquad Eq . 5$$

$${c}_{l , i , f , p , s} = {p}_{l , p , s}^{( 1 )} {p}_{l , i , f , p , s}^{( 2 )} {φ}_{l , i , f , p , s} \qquad Eq . 6$$

where γₗ is a scaling factor such that:

$${( {w}_{l}^{( t )} )}^{H} {w}_{l}^{( t )} = \frac{1}{v} \qquad Eq . 7$$

v is the number of layers,

$${w}_{s , l}^{( t )}$$

is the precoder associated with the sth CSI-RS resource or TRP and consists of two parts,

$${w}_{s , l , 0}^{( t )}$$

for a first polarization and

$${w}_{s , l , 1}^{( t )}$$

for a second polarization,

$${n}_{3 , l}^{( f )} ∈ \{ 0 , 1 , … , {N}_{3} - 1 \}$$

is a FD basis vector index of the f^{th} selected FD basis vector,

$${c}_{l , i , f , p , s} = {p}_{l , p , s}^{( 1 )} {p}_{l , i , f , p , s}^{( 2 )} {φ}_{l , i , f , p , s}$$

is the coefficient c_{l,i,f} associated with polarization index p and CSI-RS resource index s, and

$${p}_{l , p , s}^{( 1 )}$$

is the wideband amplitude associated with layer l, polarization index p, and CSI-RS resource index s, and

$${p}_{l , i , f , p , s}^{( 2 )}$$

is the subband amplitude associated with layer l, the i^{th} selected spatial beam, the f^{th} selected FD basis vector, polarization index p, and CSI-RS resource index s.

In one embodiment, the total number of selected beams, L′, by the UE 506 can be smaller than the number of configured beams, i.e.,

$${L}^{′} = {\sum }_{s = 1}^{{N}_{RS}} {L}_{S} < L .$$

This is useful since the actual useful beams seen by the UE 506 may be less than the configured beams and the feedback overhead can be reduced when L′<L.

In some scenarios, not all the configured TRPs are suitable for CJT for a UE 506 and the UE 506 may determine that a subset of the TRPs or CSI-RS resources may be suitable for participating CJT. When a TRP is not selected for CJT by the UE 506, there is no selected beam associated with the TRP or CSI-RS resource. Thus, in one embodiment, the number of selected beams for each of the configured CSI-RS resources is also reported as part of the CSI, i.e., {L₁, . . . , L_{N}_{_{RS}}} are reported, where Lₛ=0, s∈(1, . . . , N_{RS}) means that the sth CSI-RS resource or TRP is not selected for CJT.

In step 606 the method includes receiving from the UE 506, a CSI report comprising CSI associated to L′ spatial beams, where L′ spatial beams is fewer than L spatial beams. When L′<L is supported, the CSI payload size can vary depending on L′. To help the network to determine the payload size for proper decoding, in one embodiment, L′ is reported in part 1 of the CSI report. Part 1 has a fixed payload size and after decoding part 1 of the CSI report, gNB should know L′ and thus can determine the payload size of Part 2 of the CSI. Alternatively, the number of selected beams associated with each CSI-RS resource, i.e., {L₁, . . . , L_{N}_{_{RS}}}, are reported in Part 1. Part 1 of the CSI contains information necessary to determine the payload size of the part 2 of the CSI.

The reported CSI would comprise:
Part 1:
   Number of layers or a rank indicator (RI): v
   Total number of selected beams: L′; in some embodiments the number of selected beams for each CSI-RS resource, i.e., {L₁, . . . , L_{N}_{_{RS}}}, may be indicated in CSI part 1.
   A total number of non-zero coefficients across all layers
   CQI
Part 2:
   Number of selected beams associated with each CSI-RS resource: {L₁, . . . , L_{N}_{_{RS}}} if they are not reported in Part 1.
   beam indices of selected beams

$$\{ {v}_{{m}_{1 , s}^{( i )} , {m}_{2 , s}^{( i )}}^{s} , i = 0 , 1 , … , {L}_{s} - 1 ; s = 1 , … , {N}_{RS} \}$$

for each selected CSI-RS resources, i.e.,

$$\{ {n}_{1 , s}^{( i )} , {n}_{2 , s}^{( i )} , {q}_{1 , s} {q}_{2 , s} , i = 0 , 1 , … , {L}_{s} - 1 ; s = 1 , … , {N}_{RS} \}$$

Indices of selected FD basis vectors

$$\{ {y}_{l}^{( 0 )} , {y}_{l}^{( 1 )} , … , {y}_{l}^{( {M}_{ν} - 1 )} \}$$

for each layer
A length with 2L′Mᵥ bits Non-zero coefficient bitmap for each layer
Quantized Wideband amplitude

$${p}_{l , p , s}^{( 1 )}$$

per layer, per polarization, and per CSI-RS resource, associated with non-zero coefficients.
For each layer, indices {i*, s*, p*} for co-efficient c_{l,i*,f*,p*,s*} with the maximum amplitude across all selected CSI-RS resources, all the selected FD basis vector, and both polarizations

$${i}^{*} ∈ \{ 0 , 1 , … , {L}_{s} - 1 \} ; {s}^{*} ∈ \{ 1 , … , {N}_{RS} \} ; {p}^{*} ∈ \{ 0 , 1 \}$$

$${c}_{l , i * , f * , p * , s *} = 1$$

c_{l,i,f,p,s} is normalized by

$${c}_{l , i * , f * , p * , s *} , i . e . , {\tilde{c}}_{l , i , f , p , s} = \frac{{c}_{l , i , f , p , s}}{{c}_{l , i * , f * , p * , s *}}$$

φ_{l,i,f,p,s} is a quantized version of the phase factor of \tilde{c}_{l,i,f,p,s}

$${p}_{l , p , s}^{( 1 )} {p}_{l , i , f , p , s}^{( 2 )}$$

is a quantized version of the amplitude of \tilde{c}_{l,i,f,p,s}
f* is not reported but the columns of W_{f,l} are circularly shifted such that f* corresponds to the 1^{st} column, the reported

$$\{ {y}_{l}^{( 0 )} , {y}_{l}^{( 1 )} , … , {y}_{l}^{( {M}_{ν} - 1 )} \}$$

is after the corresponding circularly shift

When Lₛ=0 is reported in Part 1, it is understood that the sth CSI-RS resource is not selected for the CJT CSI calculation above and thus, the associated parameters are not reported in Part 2.

In step 608 of the method, the gNB constructs a precoding matrix according to Eq.1 to Eq.7 for each of the multiple TRPs based on the CJT CSI report and in step 610 of the method, applies the precoding matrices to a PDSCH before being transmitted at the multiple TRPs 502 and 504.

In another embodiment, the number of selected FD basis vectors is based on the number of CSI-RS resources from which at least one beam or port is selected. For instance, the number of selected FD basis vectors for the CJT case can be defined as

$${M}_{v} = ⌈ {p}_{v}^{′} \frac{{N}_{3}}{R} ⌉ ,$$

where the parameter p′ᵥ depends on the number of TRPs from which beams or ports are selected (recall that the number of TRPs selected is given by the number of CSI-RS resources from which at least one beam or port is selected). For larger number of TRPs selected, larger values of p′ᵥ may be specified. This is beneficial as a larger number of TRPs selected for CJT will likely result in a larger delay spread in which case selecting a larger p′ᵥ will result in a larger number of selected FD basis vectors. Similarly, for smaller number of TRPs selected, smaller values of p′ᵥ may be specified which can be used to select a smaller number of FD basis vectors.

Although two TRPs 502 and 504 are used for discussion in the above examples, the ideas can be easily extended to more than two TRPs.

In FIG. 7, the method 700, which is a method performed by the UE 506 starts at step 702 where the method includes receiving configuration from a network node with a type-II Codebook, CB, based CSI report comprising NRS CSI Reference Signal, CSI-RS, resources and a total number of L spatial beams for CJT.

At step 704, the method includes receiving a transmission comprising the NRS CSI-RS resources and a request to report the type-II CB based CJT CSI according to the CSI Report configuration in step 702.

At step 706, the method includes measuring channels based on the N_{RS} CSI-R resources and calculating a CSI based on an aggregation of the measured channels by selecting L′ spatial beams, where L′ is an integer and is smaller than or equal to L spatial beams.

As part of step 706, the UE 506 will then obtain an aggregated DL channel \tilde{H}=[\tilde{H}₁, . . . , \tilde{H}_{N}_{_{RS}}] from the individual per TRP channel estimation \tilde{H}_{S}, based on the sth CSI-RS resource. If different PDSCH to CSI-RS power offsets are configured for different CSI-RS resources, the channel measured on each of the CSI-RS resources need to be scaled according to the configured power offset before forming the aggregated channel. For example, if a power offset of −3 dB is configured for a CSI-RS resource, the measured channel based on the CSI-RS resource needs to be scaled by

$$\frac{1}{\sqrt[2]{2}} .$$

The UE 506 calculates a Type II PMI based on the aggregated DL channel \tilde{H}. It can be assumed that the UE 506 is configured with a set of parameters for the CJT CSI report as follows:
L: the total number of spatial beams across all CSI-RS resources or TRP
R∈{1,2}: a scaling factor for PMI subband size
pᵥ: a parameter used to configure the number FD basis vectors for a given rank v, i.e.,

$${M}_{v} = ⌈ {p}_{v} \frac{{N}_{3}}{R} ⌉ ,$$

where N₃=N_{CQI}R and N_{CQI} is a number of CQI subbands
β: a parameter used to configure the maximum number of non-zero coefficients (NZCs), i.e., K₀=┌β2LM₁┐, for each layer. The total number of NZCs across all layers, K^{NZ}≤2K₀

For MIMO layer l, the precoder matrix Wₗ across all TRPs is given by a size P_{CSI-RS}×N₃ matrix

$${W}_{l} = [ {w}_{l}^{( 0 )} … {w}_{l}^{( {N}_{3} - 1 )} ] = {W}_{1} {\tilde{W}}_{2 , l} {W}_{f , l}^{H} ,$$

where

$${w}_{l}^{( t )}$$

is a P_{CSI-RS}×1 precoding vector at a subband with subband index t∈{0,1, . . . , N₃−1} for layer l, where

$${P}_{CSI - RS} = {\sum }_{s = 1}^{{N}_{RS}} {P}_{CSI - RS , s}$$

is the total number of CSI-RS ports in all the N_{RS} NZP CSI-RS resources, P_{CSI-RS,s}=2N_{1,s}N_{2,s} is the number of CSI-RS ports in the s^{th} NZP CSI-RS resource, where N_{1,s} and N_{2,s} are the number of antenna ports in a first and a second dimensions. Note that the number of CSI-RS ports in different NZP CSI-RS resources may be same or different.

$${W}_{1} = diag ( {W}_{1}^{( 1 )} , … , {W}_{1}^{( {N}_{RS} )} )$$

is a size P_{CSI-RS}×2L′ block diagonal spatial matrix, where L′ is the total number of selected spatial beams associated with all the N_{RS} NZP CSI-RS resources

$${W}_{1}^{( s )} = [ \begin{matrix}{v}_{{m}_{1}^{( 0 )} , {m}_{2}^{( 0 )}}^{( s )} , … , {v}_{{m}_{1}^{( {L}_{s} - 1 )} , {m}_{2}^{( {L}_{s} - 1 )}}^{( s )} & 0 \\ 0 & {v}_{{m}_{1}^{( 0 )} , {m}_{2}^{( 0 )}}^{( s )} , … , {v}_{{m}_{1}^{( {L}_{s} - 1 )} , {m}_{2}^{( {L}_{s} - 1 )}}^{( s )}\end{matrix} ]$$

is a size P_{CSI-RS,s}×2Lₛ precoding matrix associated with the s^{th} NZP CSI-RS resource, s=1, . . . , N_{RS} and

$${L}^{′} = {\sum }_{s = 1}^{{N}_{RS}} {L}_{s} .$$

$$\{ {v}_{{m}_{1 , s}^{( 0 )} , {m}_{2 , s}^{( 0 )}}^{( s )} , … , {v}_{{m}_{1 , s}^{( {L}_{s} - 1 )} , {m}_{2 , s}^{( {L}_{s} - 1 )}}^{( s )} \}$$

is a set of size P_{CSI-RS,s}/2×1 selected 2-D DFT beams

$${v}_{{m}_{1 , s}^{( i )} , {m}_{2 , s}^{( i )}}^{( s )} = {[ {u}_{{m}_{2}^{( i )}}^{( s )} , {e}^{j \frac{2 π {m}_{1 , s}^{( i )}}{{O}_{1 , s} {N}_{1 , s}}} {u}_{{m}_{2}^{( i )}}^{( s )} , … , {e}^{j \frac{2 π {m}_{1 , s}^{( i )} ( {N}_{1 , s} - 1 )}{{O}_{1 , s} {N}_{1 , s}}} {u}_{{m}_{2}^{( i )}}^{( s )} ]}^{T} \\ {u}_{{m}_{2}^{( i )}}^{( s )} = {[ 1 , {e}^{j \frac{2 {πm}_{2}^{( i )}}{{O}_{2 , s} {N}_{2 , s}}} , … , {e}^{j \frac{2 π {m}_{2}^{( i )} ( {N}_{2 , s} - 1 )}{{O}_{2 , s} {N}_{2 , s}}} ]}^{T} if {N}_{2 , s} > 1 and {u}_{{m}_{2}^{( i )}}^{( s )} = 1 if {N}_{2 , s} = 1 \\ {m}_{1 , s}^{( i )} = {O}_{1 , s} {n}_{1 , s}^{( i )} + {q}_{1 , s} , {m}_{2 , s}^{( i )} = {O}_{2 , s} {n}_{2 , s}^{( i )} + {q}_{2 , s} , \\ {n}_{1 , s}^{( i )} ∈ \{ 0 , 1 , … , {N}_{1 , s} - 1 \} , {n}_{2 , s}^{( i )} ∈ \{ 0 , 1 , … , {N}_{2 , s} - 1 \} , \\ {q}_{1 , s} ∈ \{ 0 , 1 , … , {O}_{1 , s} - 1 ) , {q}_{2 , s} ∈ \{ 0 , 1 , … , {O}_{2 , s} - 1 ) , \\ i = 0 , 1 , … {L}_{s} - 1 ,$$

and O_{1,s} and O_{2,s} are the oversampling factors along dimensions of N_{1,s} and N_{2,s}, respectively.
If port selection type II CSI is configured, then each of the CSI-RS ports in all the CSI-RS resources corresponds to 2-D spatial beam and

$${W}_{1}^{s} = [ \begin{matrix}{e}_{{m}_{s}^{( 0 )}}^{( s )} , … , {e}_{{m}_{s}^{( {L}_{s} - 1 )}}^{( s )} & 0 \\ 0 & {e}_{{m}_{s}^{( 0 )}}^{( s )} , … , {e}_{{m}_{s}^{( {L}_{s} - 1 )}}^{( s )}\end{matrix} ] ,$$

where

$${e}_{{m}^{( i )}}^{( s )} ( i = 0 , 1 , … , {L}_{s} - 1 )$$

is a P_{CSI-RS,s}/2×1 vector containing a value of 1 in the element of index

$${m}_{s}^{{( i )}_{}}$$

and zeros elsewhere where the first element is the element of index 0,

$${m}_{s}^{( i )} ∈ \{ 0 , 1 , … , \frac{{P}_{CSI - RS , s}}{2} - 1 \}$$

$${W}_{f , l} = [ {y}_{l}^{( 0 )} , {y}_{l}^{( 1 )} , … , {y}_{l}^{( {M}_{ν} - 1 )} ]$$

is a size-N₃×Mᵥ frequency domain (FD) compression matrix comprising Mᵥ selected FD basis vectors, where

$${y}_{l}^{( f )} ∈ \{ {y}_{0} {y}_{1} … {y}_{{N}_{3} - 1} \} ,$$

and yₖ=[y_{k,0},y_{k,1}, . . . , y_{k,N}_{₃}₋₁]^{T} and y_{k,t}=e^{-j2πkt/N}^{₃}, k, t=0,1, . . . , N₃−1. W_{f,l} is common for all CSI-RS resources or TRPs

$${\tilde{W}}_{2 , l} = [ \begin{matrix}{\tilde{W}}_{2 , l , 1} \\ … \\ {\tilde{W}}_{2 , l , {N}_{RS}}\end{matrix} ] = [ {c}_{l , i , f} , i = 0 , 1 , … , 2 {L}^{′} - 1 , f = 0 , 1 , … , {M}_{v} - 1 ]$$

is a size 2L′×Mᵥ coefficient matrix
N₃ is the number of PMI subbands, common for all CSI-RS resources or TRPs

In an alternative expression, each of the precoding vector

$${w}_{l}^{( t )}$$

can be expressed as follows:

$${w}_{l}^{( t )} = {γ}_{l} [ \begin{matrix}{w}_{1 , l}^{( t )} \\ … \\ {w}_{{N}_{RS} , l}^{( t )}\end{matrix} ] , l = 1 , … , v , \qquad Eq . 8$$

$${w}_{s , l}^{( t )} = [ \begin{matrix}{w}_{s , l , 0}^{( t )} \\ {w}_{s , l , 1}^{( t )}\end{matrix} ] , s = 1 , … , {N}_{R S} . \qquad Eq . 9$$

$${w}_{s , l , p}^{( t )} = {\sum }_{i = 0}^{{L}_{s} - 1} {ν}_{{m}_{1 , s}^{( i )} {m}_{2 , s}^{( i )}}^{s} {\sum }_{f = 0}^{{M}_{ν} - 1} {c}_{l , i , f , p , s} {y}_{t , l}^{( f )} , p = 0 , 1 \qquad Eq . 10$$

$${y}_{t , l}^{( f )} = {e}^{j \frac{2 π t {n}_{3 , l}^{( f )}}{{N}_{3}}} , \qquad Eq . 11$$

$${c}_{l , i , f , p , s} = {p}_{l , p , s}^{( 1 )} {p}_{l , i , f , p , s}^{( 2 )} {φ}_{l , i , f , p , s} \qquad Eq . 12$$

where γₗ is a scaling factor such that:

$${( {w}_{l}^{( t )} )}^{H} {w}_{l}^{( t )} = \frac{1}{v} \qquad Eq . 13$$

v is the number of layers,

$${w}_{s , l}^{( t )}$$

is the precoder associated with the sth CSI-RS resource or TRP and consists of two parts,

$${w}_{s , l , 0}^{( t )}$$

for a first polarization and

$${w}_{s , l , 1}^{( t )}$$

for a second polarization,

$${n}_{3 , l}^{( f )} ∈ \{ 0 , 1 , … , {N}_{3} - 1 \}$$

is a FD basis vector index of the f^{th} selected FD basis vector,

$${c}_{l , i , f , p , s} = {p}_{l , p , s}^{( 1 )} {p}_{l , i , f , p , s}^{( 2 )} {φ}_{l , i , f , p , s}$$

is the coefficient c_{l,i,f} associated with polarization index p and CSI-RS resource index s, and

$${p}_{l , p , s}^{( 1 )}$$

is the wideband amplitude associated with layer l, polarization index p, and CSI-RS resource index s, and

$${p}_{l , i , f , p , s}^{( 2 )}$$

is the subband amplitude associated with layer l, the i^{th} selected spatial beam, the f^{th} selected FD basis vector, polarization index p, and CSI-RS resource index s.

In one embodiment, the total number of selected beams, L′, by the UE 506 can be smaller than the number of configured beams, i.e.,

$${L}^{′} = {\sum }_{s = 1}^{{N}_{R s}} {L}_{S} < L .$$

This is useful since the actual useful beams seen by the UE 506 may be less than the configured beams and the feedback overhead can be reduced when L′<L.

In some scenarios, not all the configured TRPs are suitable for CJT for a UE 506 and the UE 506 may determine that a subset of the TRPs or CSI-RS resources may be suitable for participating CJT. When a TRP is not selected for CJT by the UE 506, there is no selected beam associated with the TRP or CSI-RS resource. Thus, in one embodiment, the number of selected beams for each of the configured CSI-RS resources is also reported as part of the CSI, i.e., {L₁, . . . , L_{N}_{_{RS}}} are reported, where Lₛ=0, s∈(1, . . . , N_{RS}) means that the sth CSI-RS resource or TRP is not selected for CJT.

At step 708, the method includes transmitting the CSI report comprising beam indices for each of the L′ spatial beams.

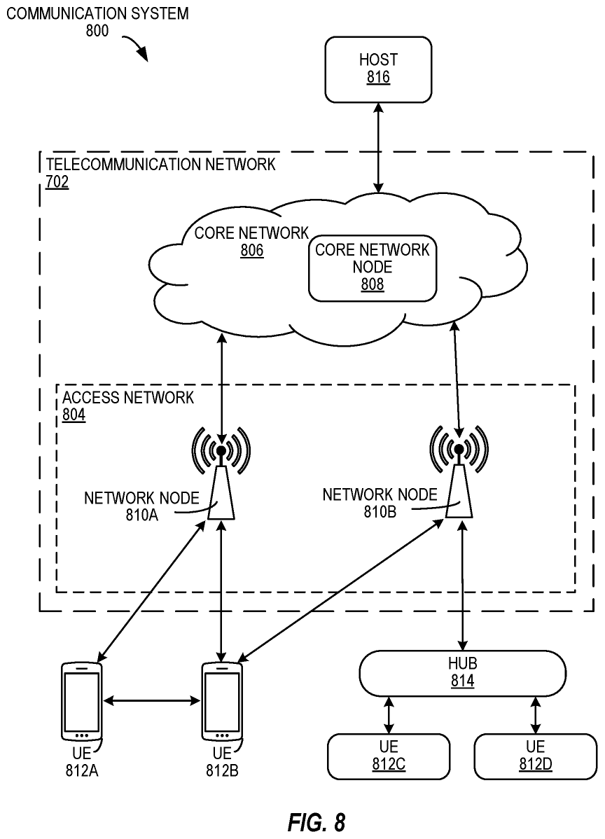

FIG. 8 shows an example of a communication system 800 in accordance with some embodiments.

In the example, the communication system 800 includes a telecommunication network 802 that includes an access network 804, such as a Radio Access Network (RAN), and a core network 806, which includes one or more core network nodes 808. The access network 804 includes one or more access network nodes, such as network nodes 810A and 810B (one or more of which may be generally referred to as network nodes 810), or any other similar Third Generation Partnership Project (3GPP) access node or non-3GPP Access Point (AP). The network nodes 810 facilitate direct or indirect connection of User Equipment (UE), such as by connecting UEs 812A, 812B, 812C, and 812D (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system 800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 802 is a cellular network that implements 3GPP standardized features. Accordingly, the telecommunication network 802 may support network slicing to provide different logical networks to different devices that are connected to the telecommunication network 802. For example, the telecommunication network 802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality (VR) headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810B. In other embodiments, the hub 814 may be a non-dedicated hub—that is, a device which is capable of operating to route communications between the UEs and the network node 810B, but which is additionally capable of operating as a communication start and/or end point for certain data channels.

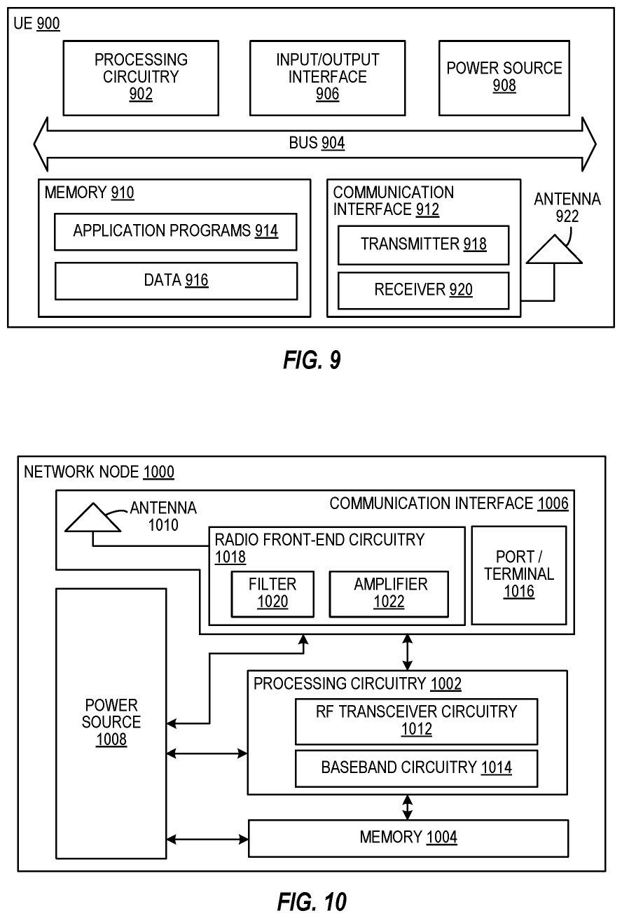

FIG. 9 shows a UE 900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 902 may include multiple Central Processing Units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging the power source 908. Power circuitry may perform any formatting, converting, or other modification to the power from the power source 908 to make the power suitable for the respective components of the UE 900 to which power is supplied.

The memory 910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 910 may allow the UE 900 to access instructions, application programs, and the like stored on transitory or non-transitory memory media, to off-load data, or to upload data. An article of manufacture, such as one utilizing a communication system, may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., the antenna 922) and may share circuit components, software, or firmware, or alternatively be implemented separately.

In the illustrated embodiment, communication functions of the communication interface 912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 912, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 10 shows a network node 1000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission/reception point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission/reception points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes processing circuitry 1002, memory 1004, a communication interface 1006, and a power source 1008. The network node 1000 may be composed of multiple physically separate components (e.g., a Node B component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1000 may be configured to support multiple RATs. In such embodiments, some components may be duplicated (e.g., separate memory 1004 for different RATs) and some components may be reused (e.g., an antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1000.

The processing circuitry 1002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1000 components, such as the memory 1004, to provide network node 1000 functionality.

In some embodiments, the processing circuitry 1002 includes a System on a Chip (SOC). In some embodiments, the processing circuitry 1002 includes one or more of Radio Frequency (RF) transceiver circuitry 1012 and baseband processing circuitry 1014. In some embodiments, the RF transceiver circuitry 1012 and the baseband processing circuitry 1014 may be on separate chips (or sets of chips), boards, or units, such as radio units and digital units. In alternative embodiments, part or all of the RF transceiver circuitry 1012 and the baseband processing circuitry 1014 may be on the same chip or set of chips, boards, or units.

The memory 1004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and the memory 1004 are integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. The radio front-end circuitry 1018 comprises filters 1020 and amplifiers 1022. The radio front-end circuitry 1018 may be connected to the antenna 1010 and the processing circuitry 1002. The radio front-end circuitry 1018 may be configured to condition signals communicated between the antenna 1010 and the processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of the filters 1020 and/or the amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface 1006 may comprise different components and/or different combinations of components.

In certain alternative embodiments, the network node 1000 does not include separate radio front-end circuitry 1018; instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes the one or more ports or terminals 1016, the radio front-end circuitry 1018, and the RF transceiver circuitry 1012 as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, the communication interface 1006, and/or the processing circuitry 1002 may be configured to perform any receiving operations and/or certain obtaining operations described herein as being performed by the network node 1000. Any information, data, and/or signals may be received from a UE, another network node, and/or any other network equipment. Similarly, the antenna 1010, the communication interface 1006, and/or the processing circuitry 1002 may be configured to perform any transmitting operations described herein as being performed by the network node 1000. Any information, data, and/or signals may be transmitted to a UE, another network node, and/or any other network equipment.

The power source 1008 provides power to the various components of the network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid or an electricity outlet) via input circuitry or an interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

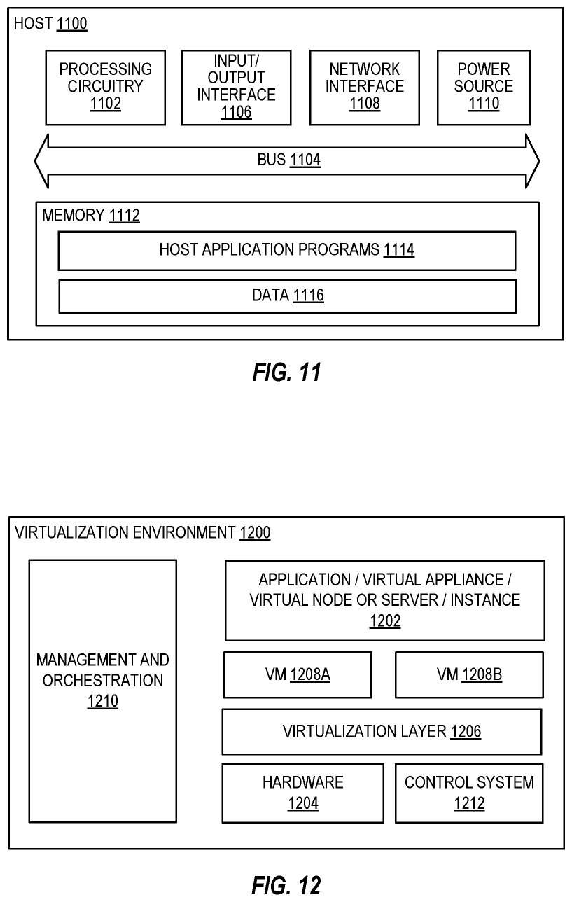

FIG. 11 is a block diagram of a host 1100, which may be an embodiment of the host 816 of FIG. 8, in accordance with various aspects described herein. As used herein, the host 1100 may be or comprise various combinations of hardware and/or software including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and memory 1112. Other components may be included in other embodiments. Features of these components may be substantially similar to those described with respect to the devices of previous figures, such as FIGS. 9 and 10, such that the descriptions thereof are generally applicable to the corresponding components of the host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for Over-The-Top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or VM Monitors (VMMs)), provide VMs 1208A and 1208B (one or more of which may be generally referred to as VMs 1208), and/or perform any of the functions, features, and/or benefits described in relation with some embodiments described herein. The virtualization layer 1206 may present a virtual operating platform that appears like networking hardware to the VMs 1208.

The VMs 1208 comprise virtual processing, virtual memory, virtual networking, or interface and virtual storage, and may be run by a corresponding virtualization layer 1206. Different embodiments of the instance of a virtual appliance 1202 may be implemented on one or more of the VMs 1208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1208 may be a software implementation of a physical machine that runs programs as if they were executing on a physical, non-virtualized machine. Each of the VMs 1208, and that part of the hardware 1204 that executes that VM, be it hardware dedicated to that VM and/or hardware shared by that VM with others of the VMs 1208, forms separate virtual network elements. Still in the context of NFV, a virtual network function is responsible for handling specific network functions that run in one or more VMs 1208 on top of the hardware 1204 and corresponds to the application 1202.

The hardware 1204 may be implemented in a standalone network node with generic or specific components. The hardware 1204 may implement some functions via virtualization. Alternatively, the hardware 1204 may be part of a larger cluster of hardware (e.g., such as in a data center or CPE) where many hardware nodes work together and are managed via management and orchestration 1210, which, among others, oversees lifecycle management of the applications 1202. In some embodiments, the hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1212 which may alternatively be used for communication between hardware nodes and radio units.

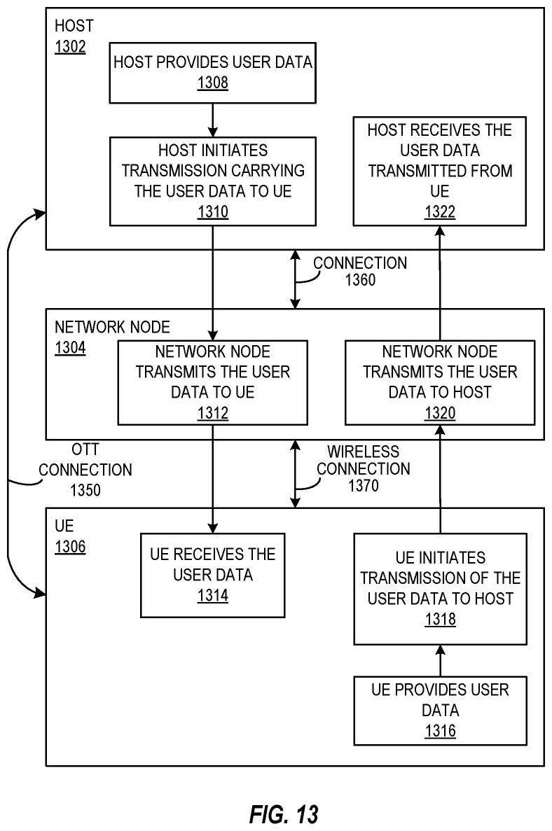

FIG. 13 shows a communication diagram of a host 1302 communicating via a network node 1304 with a UE 1306 over a partially wireless connection in accordance with some embodiments. Example implementations, in accordance with various embodiments, of the UE (such as the UE 812A of FIG. 8 and/or the UE 900 of FIG. 9), the network node (such as the network node 810A of FIG. 8 and/or the network node 1000 of FIG. 10), and the host (such as the host 816 of FIG. 8 and/or the host 1100 of FIG. 11) discussed in the preceding paragraphs will now be described with reference to FIG. 13.

Like the host 1100, embodiments of the host 1302 include hardware, such as a communication interface, processing circuitry, and memory. The host 1302 also includes software, which is stored in or is accessible by the host 1302 and executable by the processing circuitry. The software includes a host application that may be operable to provide a service to a remote user, such as the UE 1306 connecting via an OTT connection 1350 extending between the UE 1306 and the host 1302. In providing the service to the remote user, a host application may provide user data which is transmitted using the OTT connection 1350.

The network node 1304 includes hardware enabling it to communicate with the host 1302 and the UE 1306 via a connection 1360. The connection 1360 may be direct or pass through a core network (like the core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by the UE 1306 and executable by the UE's processing circuitry. The software includes a client application, such as a web browser or operator-specific “app” that may be operable to provide a service to a human or non-human user via the UE 1306 with the support of the host 1302. In the host 1302, an executing host application may communicate with the executing client application via the OTT connection 1350 terminating at the UE 1306 and the host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via the connection 1360 between the host 1302 and the network node 1304 and via a wireless connection 1370 between the network node 1304 and the UE 1306 to provide the connection between the host 1302 and the UE 1306. The connection 1360 and the wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304 in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may reduce the feedback overhead, especially when L′ is <L, thus improving performance.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR, or AR which it can broadcast, multicast, or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1350 between the host 1302 and the UE 1306 in response to variations in the measurement results. The measurement procedure and/or the network functionality for reconfiguring the OTT connection 1350 may be implemented in software and hardware of the host 1302 and/or the UE 1306. In some embodiments, sensors (not shown) may be deployed in or in association with other devices through which the OTT connection 1350 passes; the sensors may participate in the measurement procedure by supplying values of the monitored quantities exemplified above, or by supplying values of other physical quantities from which software may compute or estimate the monitored quantities. The reconfiguring of the OTT connection 1350 may include message format, retransmission settings, preferred routing, etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency, and the like by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Embodiment 1: A method performed by one or more network nodes (502, 504) for reducing Channel State Information, CSI, reporting overhead for Coherent Joint Transmissions, CJT, to a User Equipment device, UE, from multiple Transmission and Reception Points, TRPs, the method comprising: configuring (602) the UE (506) with a type-IT Codebook, CB, based CSIreport configuration comprising N_{RS} CSI Reference Signal, CSI-RS, resources each associated to one of the multiple TRPs and a parameter L, which specifying a maximum number of spatial beams comprised in the CSI for CJT; transmitting (604) the N_{RS} CSI-RS resources and requesting that the UE (506) reports the type-II CB based CSI according to the CSI Report configuration; receiving (606), from the UE (506), a CSI report comprising CSI associated with L′ spatial beams, where L′ is an integer and is smaller than or equal to L; constructing (608) a precoding matrix for each of the multiple TRPs based on the CSI report; and applying (610) the precoding matrix to a Physical Downlink Shared Channel, PDSCH, at each of the multiple TRPs.

Embodiment 2: The method of embodiment 1, wherein the L′ spatial beams are selected beams associated to one or more of the CSI-RS resources, and wherein if there is no beam associated to one of the CSI-RS resources is selected, the corresponding TRP is not used for the CJT to the UE (506) and no precoding matrix associated to the TRP is reported in the CSI.

Embodiment 3: The method of embodiment 1, wherein the CSI report configuration further comprises a number of FD basis vectors to be selected.

Embodiment 4: The method of embodiment 3, wherein the number of FD basis vectors is based on a number of CSI resources.

Embodiment 5: The method of any of embodiments 1-4, wherein the CSI report comprises a first part that comprises one or more of, a number of layers or a rank indicator, RI, a number of L′ spatial beams, a number of selected spatial beams associated to each of the CSI-RS resources, a number of non-zero coefficients across all layers; and a channel quality indicator, CQI.

Embodiment 6: The method of any of embodiments 1-5, wherein the CSI report comprises a second part that comprises one or more of: a number of selected beams associated with each CSI-RS resource if it is not reported in Part 1; beam indices of the L′ selected beams; indices of a number of selected Frequency Domain, FD, basis vectors for each layer; a non-zero coefficients bitmap for each layer, where each bit in the bitmap is associated to a coefficient which is associated to a selected beam and a selected FD basis vector at a polarization, and where a non-zero coefficient is indicated by setting the corresponding bit to one; a quantized wideband amplitude per layer, per polarization, and per CSI-RS resource; a quantized subband amplitude relative to the corresponding wideband amplitude for each of the non-zero coefficients; a quantized phase information for each of the non-zero coefficients; and for each layer, each polarization, and each CSI-RS resource, a beam index associated to a non-zero coefficient with the maximum amplitude.

Embodiment 7: The method of embodiment 6, wherein a size of the second part of the CSI report is based on the number of the selected beams.

Embodiment 8: The method of any of embodiments 1-7, wherein the UE (506) is configured with a set of parameters for the CSI Report, the set of parameters comprising: the total number of L spatial beams; a scaling factor for Precoder Matrix Indicator, PMI, subband size; a parameter used to configure a number of FD basis vectors for a given rank; and a parameter used to configure the maximum number of non-zero coefficients for each layer.

Embodiment 9: A network node (502, 504), comprising a memory that stores computer-executable instructions; and a processor that executes the computer-executable instruction to perform operations, comprising: configuring (602) a User Equipment device, UE (506), with a type-II Codebook, CB, based Channel State Information, CSI, Report comprising N_{RS} CSI Reference Signal, CSI-RS, resources and a parameter L which specifying a maximum number of spatial beams comprised in the CSI for Coherent Joint Transmission, CJT; transmitting (604) the N_{RS} CSI-RS resources and requesting that the UE (506) reports the type-II CB based CSI according to the CSI report configuration; receiving (606), from the UE (506), a CSI report comprising CSI associated with L′ spatial beams, where L′ is an integer and is smaller than or equal to L; constructing (608) a precoding matrix for each of the multiple Transmission Reception Points, TRPs, based on the CSI report; and applying (610) the precoding matrix to a Physical Downlink Shared Channel, PDSCH, at each of the multiple TRPs.

Embodiment 10: The network node of embodiment 9, wherein the L′ spatial beams are selected beams associated to one or more of the CSI-RS resources, and wherein if there is no beam associated to one of the CSI-RS resources is selected, the corresponding TRP is not used for the CJT to the UE (506) and no precoding matrix associated to the TRP is reported in the CSI.

Embodiment 11: The method of embodiment 9, wherein the CSI report configuration further comprises a number of FD basis vectors to be selected.

Embodiment 12: The method of embodiment 11, wherein the number of FD basis vectors is based on a number of CSI resources.

Embodiment 13: The network node of any of embodiments 9-12, wherein the CSI report comprises a first part that comprises one or more of: a number of layers or a rank indicator, RI; a number of L′ spatial beams; a number of selected spatial beams associated to each of the CSI-RS resources; a number of non-zero coefficients across all layers; and a channel quality indicator, CQI.

Embodiment 14: The network node of embodiment 13, wherein the CSI report comprises a second part that comprises one or more of: a number of selected beams associated with each CSI-RS resource if it is not reported in the first part; beam indices of the L′ selected beams; indices of a number of selected Frequency Domain, FD, basis vectors for each layer; a non-zero coefficient bitmap for each layer, where each bit in the bitmap is associated to a coefficient which is associated to a selected beam and a selected FD basis vector at a polarization, and where a non-zero coefficient is indicated by setting the corresponding bit to one; a quantized wideband amplitude per layer, per polarization, and per CSI-RS resource; a quantized subband amplitude relative to the corresponding wideband amplitude for each of the non-zero coefficients; a quantized phase information for each of the non-zero coefficients; and for each layer, each polarization, and each CSI-RS resource, a beam index associated to a non-zero coefficient with the maximum amplitude.

Embodiment 15: The network node of embodiment 14, wherein a size of the second part of the CSI report is based on the number of the selected beams.

Embodiment 16: The network node of any of embodiments 9-15, wherein the UE (506) is configured with a set of parameters for the CSI Report, the set of parameters comprising: the total number of L spatial beams; a scaling factor for Precoder Matrix Indicator, PMI, subband size; a parameter used to configure a number of FD basis vectors for a given rank; and a parameter used to configure the maximum number of non-zero coefficients for each layer.

Embodiment 17: A method performed by a User Equipment device 506, UE, for reducing Channel State Information, CSI, reporting overhead for Coherent Joint Transmissions, CJT, from multiple Transmission Reception Points, TRPs, the method comprising: receiving (702) configuration from a network node (502, 504) with a type-II Codebook, CB, based CSI report configuration comprising N_{RS} CSI Reference Signal, CSI-RS, resources each associated to one of the multiple TRPs and a maximum total number of L spatial beams comprised in the CSI for CJT; receiving (704) a transmission comprising the N_{RS} CSI-RS resources and a request to report the type-II CB based CSI according to the CSI Report configuration; measuring (706) channels based on the N_{RS} CSI-R resources and calculating a CSI based on an aggregation of the measured channels by selecting L′ spatial beams, where L′ is an integer and is smaller than or equal to L; and transmitting (708) the CSI report comprising beam indices for each of the L′ spatial beams.

Embodiment 18: The method of embodiment 17, wherein the L′ spatial beams are selected beams associated to one or more of the CSI-RS resources, and wherein if there is no beam associated to one of the CSI-RS resources is selected, the corresponding TRP is not used for the CJT to the UE (506) and no precoding matrix associated to the TRP is reported in the CSI.

Embodiment 19: The method of embodiment 17, wherein the CSI report configuration further comprises a number of FD basis vectors to be selected.

Embodiment 20: The method of embodiment 19, wherein the number of FD basis vectors is based on a number of CSI resources.

Embodiment 21: The method of any of embodiments 17-20, wherein the CSI report comprises a first part that comprises one or more of: a number of layers or a rank indicator, RI; a number of L′ spatial beams; a number of selected spatial beams associated to each of the CSI-RS resources; a number of non-zero coefficients across all layers; and a channel quality indicator, CQI.

Embodiment 22: The method of embodiment 21, wherein the CSI report comprises a second part that comprises one or more of: a number of selected beams associated with each CSI-RS resource if it is not reported in the first part; beam indices of the L′ selected beams; indices of a number of selected Frequency Domain, FD, basis vectors for each layer; a non-zero coefficient bitmap for each layer, where each bit in the bitmap is associated to a coefficient which is associated to a selected beam and a selected FD basis vector at a polarization, and where a non-zero coefficient is indicated by setting the corresponding bit to one; a quantized wideband amplitude per layer, per polarization, and per CSI-RS resource; a quantized subband amplitude relative to the corresponding wideband amplitude for each of the non-zero coefficients; a quantized phase information for each of the non-zero coefficients; and for each layer, each polarization, and each CSI-RS resource, a beam index associated to a non-zero coefficient with the maximum amplitude.

Embodiment 23: The method of embodiment 22, wherein a size of the second part of the CSI report is based on the number of the selected beams.

Embodiment 24: The method of any of embodiments 17-23, wherein the UE (506) is configured with a set of parameters for the CSI Report, the set of parameters comprising: the total number of L spatial beams; a scaling factor for Precoder Matrix Indicator, PMI, subband size; a parameter used to configure a number of FD basis vectors for a given rank; and a parameter used to configure the maximum number of non-zero coefficients for each layer.

Embodiment 25: A User Equipment device, comprising a memory that stores computer-executable instructions; and a processor that executes the computer-executable instruction to perform operations, comprising: receiving (702) configuration from a network node (502, 504) with a type-II Codebook, CB, based CSI report configuration comprising N_{RS} CSI Reference Signal, CSI-RS, resources and a maximum total number of L spatial beams comprised in the CSI for CJT; receiving (704) a transmission comprising the N_{RS} CSI-RS resources and a request to report the type-II CB based CSI according to the CSI Report configuration; measuring (706) channels based on the N_{RS} CSI-R resources and calculating a CSI based on an aggregation of the measured channels by selecting L′ spatial beams, where L′ is an integer and is smaller than or equal to L; and transmitting (708) the CSI report comprising beam indices for each of the L′ spatial beams.

Embodiment 26: The method of embodiment 25, wherein the L′ spatial beams are selected beams associated to one or more of the CSI-RS resources, and wherein if there is no beam associated to one of the CSI-RS resources is selected, the corresponding TRP is not used for the CJT to the UE (506) and no precoding matrix associated to the TRP is reported in the CSI.

Embodiment 27: The method of embodiment 25, wherein the CSI report configuration further comprises a number of FD basis vectors to be selected.

Embodiment 28: The method of embodiment 27, wherein the number of FD basis vectors is based on a number of CSI resources.

Embodiment 29: The method of any of embodiments 25-28, wherein the CSI report comprises a first part that comprises one or more of: a number of layers or a rank indicator, RI; a number of L′ spatial beams; a number of selected spatial beams associated to each of the CSI-RS resources; a number of non-zero coefficients across all layers; and a channel quality indicator, CQI.

Embodiment 30: The method of embodiment 29, wherein the CSI report comprises a second part that comprises one or more of: a number of selected beams associated with each CSI-RS resource if it is not reported in the first part; beam indices of the L′ selected beams; indices of a number of selected Frequency Domain, FD, basis vectors for each layer; a non-zero coefficient bitmap for each layer, where each bit in the bitmap is associated to an coefficient which is associated to a selected beam and a selected FD basis vector at a polarization, and where a non-zero coefficient is indicated by setting the corresponding bit to one; a quantized wideband amplitude per layer, per polarization, and per CSI-RS resource; a quantized subband amplitude relative to the corresponding wideband amplitude for each of the non-zero coefficients; a quantized phase information for each of the non-zero coefficients; and for each layer, each polarization, and each CSI-RS resource, a beam index associated to a non-zero coefficient with the maximum amplitude.

Embodiment 31: The method of embodiment 30, wherein a size of the second part of the CSI report is based on the number of the selected beams.

Embodiment 32: The method of any of embodiments 25-31, wherein the UE (506) is configured with a set of parameters for the CSI Report, the set of parameters comprising: the total number of L spatial beams; a scaling factor for Precoder Matrix Indicator, PMI, subband size; a parameter used to configure a number of FD basis vectors for a given rank; and a parameter used to configure the maximum number of non-zero coefficients for each layer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a User Equipment, UE, device, for Channel State Information, CSI, reporting for Coherent Joint Transmissions, CJT, the method comprising:
receiving configuration from a network node with a CSI report configuration comprising an indication of N_{RS}>1 CSI Reference Signal, CSI-RS, resources for channel measurement and a codebook configuration;
receiving a transmission comprising the N_{RS} CSI-RS resources and a request to report CSI according to the CSI Report configuration;
measuring channels based on the N_{RS} CSI-RS resources and computing a CSI based on the measured channels, wherein the computing comprises determining a number of spatial beams or CSI-RS ports for each CSI-RS resource of the N_{RS} CSI-RS resources; and
transmitting a CSI report comprising a first part and a second part, wherein the first part comprises an indication of the number of spatial beams or CSI-RS ports for each of the N_{RS} CSI-RS resources.

2. The method of claim 1, wherein each of the N_{RS} CSI-RS resources is associated to one of multiple Transmission Reception Points, TRPs.

3. The method of claim 1, wherein the codebook configuration further comprises an indication a type II codebook of precoding matrices, wherein each column of a precoding matrix in the codebook is a linear combination of multiple spatial beams or CSI-RS ports.

4. The method of claim 2, wherein if there is no spatial beam or CSI-RS port selected for one of the CSI-RS resources, the corresponding CSI-RS resource or TRP is not selected for the CJT to the UE and no precoding matrix associated to the TRP is reported in the CSI.

5. The method of claim 1, wherein the CSI report configuration further comprises a number of Frequency Domain, FD, basis vectors to be selected.

6. The method of claim 5, wherein the number of FD basis vectors is dependent on the value of N_{RS}.

7-10. (canceled)

11. A User Equipment, UE, device, comprising
a memory that stores computer-executable instructions; and
a processor that executes the computer-executable instruction to perform operations, comprising:
receiving configuration from a network node with a CSI report configuration comprising an indication of N_{RS}>1 CSI Reference Signal, CSI-RS, resources for channel measurement and a codebook configuration;
receiving a transmission comprising the N_{RS} CSI-RS resources and a request to report CSI according to the CSI Report configuration;
measuring channels based on the N_{RS} CSI-RS resources and computing a CSI based on the measured channels, wherein the computing comprises determining a number of spatial beams or CSI-RS ports for each CSI-RS resource of the N_{RS} CSI-RS resources; and
transmitting a CSI report comprising a first part and a second part, wherein the first part comprises an indication of the number of spatial beams or CSI-RS ports for each of the N_{RS} CSI-RS resources.

12. The UE of claim 11, wherein each of the N_{RS} CSI-RS resources is associated to one of multiple Transmission Reception Points, TRPs.

13. The UE of claim 11, wherein the codebook configuration further comprises an indication a type II codebook of precoding matrices, wherein each column of a precoding matrix in the codebook is a linear combination of multiple spatial beams or CSI-RS ports.

14. The UE of claim 12, wherein if there is no spatial beam or CSI-RS port selected for one of the CSI-RS resources, the corresponding CSI-RS resource or TRP is not selected for the CJT to the UE and no precoding matrix associated to the TRP is reported in the CSI.

15. The UE of claim 11, wherein the CSI report configuration further comprises a number of Frequency Domain, FD, basis vectors to be selected.

16. The UE of claim 15, wherein the number of FD basis vectors is dependent on the value of N_{RS}.

17-20. (canceled)

21. A method performed by a User Equipment, UE, device, for Channel State Information, CSI, reporting for Coherent Joint Transmissions, CJT, the method comprising:
receiving configuration from a network node with a CSI report configuration comprising an indication of N_{RS}>1 CSI Reference Signal, CSI-RS, resources for channel measurement and a codebook configuration;
receiving a transmission comprising the N_{RS} CSI-RS resources and a request to report CSI according to the CSI Report configuration;
measuring channels based on the N_{RS} CSI-RS resources and computing a CSI based on the measured channels, wherein the computing comprises determining a number of Frequency Domain, FD, basis vectors selected based on a number of spatial beams or CSI-RS ports for each CSI-RS resource of the N_{RS} CSI-RS resources; and
transmitting the CSI report comprising a first part and a second part, wherein the first part comprises an indication of the number of spatial beams or CSI-RS ports for each of the N_{RS} CSI-RS resources, and the second part comprises indices of the determined number of FD basis vectors.

22. The method of claim 21, wherein each of the N_{RS} CSI-RS resources is associated to one of multiple Transmission Reception Points, TRPs.

23. The method of claim 21, wherein the codebook configuration further comprises an indication a type II codebook of precoding matrices, wherein each column of a precoding matrix in the codebook is a linear combination of multiple spatial beams or CSI-RS ports.

24. A User Equipment device, comprising:
a memory that stores computer-executable instructions; and
a processor that executes the computer-executable instruction to perform operations, comprising:
receiving configuration from a network node with a CSI report configuration comprising an indication of N_{RS}>1 CSI Reference Signal, CSI-RS, resources for channel measurement and a codebook configuration;
receiving a transmission comprising the N_{RS} CSI-RS resources and a request to report CSI according to the CSI Report configuration;
measuring channels based on the N_{RS} CSI-RS resources and computing a CSI based on the measured channels, wherein the computing comprises determining a number of Frequency Domain, FD, basis vectors selected based on a number of spatial beams or CSI-RS ports for each CSI-RS resource of the N_{RS} CSI-RS resources; and
transmitting the CSI report comprising a first part and a second part, wherein the first part comprises an indication of the number of spatial beams or CSI-RS ports for each of the N_{RS} CSI-RS resources, and the second part comprises indices of the determined number of FD basis vectors.

25. The UE of claim 24, wherein each of the N_{RS} CSI-RS resources is associated to one of multiple Transmission Reception Points, TRPs.

26. The UE of claim 24, wherein the codebook configuration further comprising an indication a type II codebook of precoding matrices, wherein each column of a precoding matrix in the codebook is a linear combination of multiple spatial beams or CSI-RS ports.

27. A method performed by one or more network nodes for facilitating Channel State Information, CSI, reporting for Coherent Joint Transmissions, CJT, the method comprising:
configuring the UE with a CSI report configuration comprising an indication of N_{RS}>1 CSI Reference Signal, CSI-RS, resources for channel measurement and a codebook configuration;
transmitting the N_{RS} CSI-RS resources and a request to report CSI according to the CSI Report configuration; and
receiving, from the UE, a CSI report comprising a first part and a second part, wherein the first part comprises an indication of the number of spatial beams or CSI-RS ports for each of the N_{RS} CSI-RS resources.

28. The method of claim 27, wherein each of the N_{RS} CSI-RS resources is associated to one of multiple Transmission Reception Points, TRPs.

29. The method of claim 27, wherein the codebook configuration further comprises an indication a type II codebook of precoding matrices, wherein each column of a precoding matrix in the codebook is a linear combination of multiple spatial beams or CSI-RS ports.

30. The method of claim 28, wherein if there is no spatial beam or CSI-RS port selected for one of the CSI-RS resources, the corresponding CSI-RS resource or TRP is not selected for the CJT to the UE and no precoding matrix associated to the TRP is reported in the CSI.

31. The method of claim 27, wherein the CSI report configuration further comprises a number of Frequency Domain, FD, basis vectors to be selected.

32. The method of claim 31, wherein the number of FD basis vectors is dependent on the value of N_{RS}.

33-36. (canceled)

37. A network node, comprising:
a memory that stores computer-executable instructions; and
a processor that executes the computer-executable instruction to perform operations, comprising:
configuring the UE with a CSI report configuration comprising an indication of N_{RS}>1 CSI Reference Signal, CSI-RS, resources for channel measurement and a codebook configuration;
transmitting the N_{RS} CSI-RS resources and a request to report CSI according to the CSI Report configuration; and
receiving, from the UE, a CSI report comprising a first part and a second part, wherein the first part comprises an indication of the number of spatial beams or CSI-RS ports for each of the N_{RS} CSI-RS resources.

38-52. (canceled)
